(19) United States
(12) Patent Application Publication
(10) Pub. No.: US 2017/0092021 A1
(43) Pub. Date: Mar. 30, 2017

(54) METHOD AND SYSTEM FOR MONITORING EQUIPMENT

(71) Applicant: Northern VO ApS, kgs. Lyngby (DK)

(72) Inventors: Lars Dybdahl Nielsen, Espergærde (DK); Paul Fischer, kgs. Lyngby (DK)

(21) Appl. No.: 15/126,908

(22) PCT Filed: Mar. 19, 2015
(86) PCT No.: PCT/DK2015/050059

§ 371 Date: Sep. 16, 2016

(30) Foreign Application Priority Data
Mar. 19, 2014 (DK) PA201470136

(51) Int. Cl. G07C 5/08; G06F 17/50

(52) U.S. Cl. CPC G07C 5/0808; G06F 17/5009

(57) ABSTRACT

The present invention relates to a vehicle monitoring system for improving the maintenance of equipment, in particular vehicles. One embodiment relates to of a monitoring system for attachment to a craft/vehicle and for monitoring the condition of said vehicle, comprising at least one inertial measurement unit configured to measure the triple-axis proper acceleration, velocity and angular orientation of the chassis of the vehicle sampled over a time period, at least one GPS receiver for measuring the location of the vehicle, a computer comprising memory and a processing unit configured for executing any of the methods described herein for assessing the condition of said vehicle.

The present invention relates to a method and a system for monitoring equipment, such as vehicles and machinery, in particular for improving the maintenance of the equipment.

### BACKGROUND OF INVENTION

The purpose of maintenance is to avoid or mitigate the consequences of failure of equipment. Run-to-failure maintenance is when components are replaced when they fail. This may be improved by applying planned and condition based maintenance wherein worn components are replaced before they actually fail in order to preserve and restore equipment reliability. This may further be improved by preventive maintenance that includes partial or complete overhauls at specified periods, oil changes, lubrication and so on. The ideal preventive maintenance program would prevent all equipment failure before it occurs to avoid corrective maintenance, i.e. repair. But history has shown that preventive maintenance does not suffer. The main challenge is the determination of maintenance time or determination of moment when maintenance should be performed.

Predictive maintenance on the other hand includes direct measurement of the equipment and the equipment is scheduled for maintenance based on monitoring of the equipment condition. Predictive maintenance is thus designed to help determine the condition of in-service equipment in order to predict when maintenance should be performed and when implemented properly it can provide substantial cost savings and higher equipment reliability.

A proper implementation of predictive maintenance requires the right information in the right time about the condition of the equipment, in reality predicting the future trend of the equipment's condition. However, by knowing which equipment needs maintenance, maintenance work can be better planned (spare parts, people, etc.) and what would have been “unplanned stops” are transformed to shorter and fewer “planned stops”. To evaluate equipment condition nondestructive testing technologies performing periodic or continuous (online) equipment condition monitoring can advantageously be applied, preferably while the equipment is in service, thereby minimizing disruption of normal system operations.

### SUMMARY OF INVENTION

An important aspect of streamlining predictive maintenance is to incorporate the massive amount of equipment monitoring data into a computerized maintenance management system so that the equipment monitoring data can be processed and evaluated in order to trigger maintenance planning, execution and reporting. Unless this is achieved, the predictive maintenance is of limited value.

A first step before the condition of machinery, e.g. a vehicle, can be assessed is the generation of a reference such that incoming (vehicle) monitoring data can be evaluated against a reference model representing the “normal” condition of the vehicle.

One embodiment of the present disclosure therefore relates to a method, preferably computer implemented, for obtaining one or more reference models representative of the normal condition of machinery, such as a vehicle, during use, the method comprising the steps of
acquiring or obtaining machinery/vehicle monitoring data comprising a plurality of parameters indicative of the triple-axis proper acceleration, angular orientation, velocity and location/position of the vehicle sampled over a time period,
selecting one or more subsets of said vehicle monitoring data parameters,
applying an orthogonal transformation to each subset thereby obtaining a set of linearly uncorrelated eigenvectors for each subset, and
computing a multi-dimensional reference model for each subset, such as by forming ellipsoids of at least two of said eigenvectors.

The velocity and the location/position, e.g. the geographical location, can be optional and may be unnecessary in the case of stationary machinery, e.g. machinery with moving parts but fixed in one location, e.g. in the case of a wind turbine. The principal component analysis is an example of an orthogonal transformation providing a set of linearly uncorrelated principal components, i.e. eigenvectors.

A second embodiment (computer implemented) method for obtaining one or more labelled reference models representative of the normal condition of a vehicle during labelled use, the method comprising the steps of
acquiring or obtaining vehicle monitoring data comprising a plurality of parameters indicative of the triple-axis proper acceleration, angular orientation, velocity and location/position of the vehicle sampled over a time period,
labelling the acquired data with respect to driving condition to obtain one or more labelled subsets, each labelled subset assigned a specific label,
applying an orthogonal transformation to each labelled subset thereby obtaining a set of eigenvectors for each labelled subset,
computing a multi-dimensional labelled reference model for each labelled subset, such as by forming ellipsoids of at least two of said eigenvectors.

In the second embodiment the data are labelled, e.g. with respect to road type or driving style in order to provide a more specific reference model. In the first embodiment the data may be unlabeled, e.g. a reference model may be generated without labelling the data with respect to e.g. road type or driving style.

As detailed later, sparsity may be introduced during the statistical analysis of the data to extract other or additional features from the data thereby e.g. revealing local variance in the monitoring data. A consequence of sparsity is that the resulting loading vectors are not necessarily orthogonal which makes it difficult to form ellipsoids. However, a multi-dimensional (labelled) reference model can still be formed based on the loading vectors. In the reference modelling described above for labelled and unlabelled data the last two steps may then be:
applying a sparse transformation, e.g. a sparse principal component analysis, for each (labelled) subset thereby obtaining a set of loading vectors for each (labelled) subset,
computing a multi-dimensional (labelled) reference model for each labelled subset based on or more of said loading vectors.

A further embodiment of the present disclosure relates to the actual evaluation of the state or condition of a vehicle based on monitoring data acquired from the vehicle. A method, preferably computer implemented, for assessing the condition of a vehicle comprising the steps of
acquiring data indicative of the triple-axis proper acceleration, angular orientation, velocity and location of the vehicle sampled over a time period,
selecting one or more subsets of said vehicle monitoring data parameters, and
assessing the condition of the vehicle by comparing at least one of said subsets to a reference model of the vehicle.

A further embodiment relates to a method, preferably computer implemented, for assessing the condition of a vehicle comprising the steps of
acquiring data indicative of the triple-axis proper acceleration, angular orientation, velocity and location of the vehicle sampled over a time period,
selecting one or more subsets of said vehicle monitoring data parameters,
applying an orthogonal transformation of at least one of said subsets thereby obtaining a set of eigenvectors for said subset,
computing a multi-dimensional status model of the vehicle, such as by forming an ellipsoid of at least a part of said set of eigenvectors,
assessing the condition of the vehicle by comparing the status model to a reference model of the vehicle.

In the case of a sparse transformation a further embodiment may relate to a method, preferably computer implemented, for assessing the condition of a vehicle comprising the steps of
acquiring data indicative of the triple-axis proper acceleration, angular orientation, velocity and location of the vehicle sampled over a time period,
selecting one or more subsets of said vehicle monitoring data parameters,
applying a sparse transformation, e.g. a sparse principal component analysis, for at least one of said subsets thereby obtaining a set of loading vectors for said subset,
computing a multi-dimensional status model of the vehicle based on at least a part of said set of loading vectors, and
assessing the condition of the vehicle by comparing the status model to a reference model of the vehicle.

The reference model may be provided according to the herein described methods. A further embodiment relates to a vehicle support system for assessing the condition of a plurality of vehicles, comprising a computer having memory and processor and configured to execute the herein described methods. The condition of a vehicle as used herein is the condition of the vehicle with regard to its appearance, quality, and/or working order.

A further embodiment relates to the implementation into a monitoring system that can be installed in a vehicle, e.g. in the form of an on-board sensor system, e.g. in the form of a vehicle monitoring system for attachment to a vehicle and for monitoring the condition of said vehicle, comprising
at least one inertial measurement unit configured to measure the triple-axis proper acceleration, velocity and angular orientation of the chassis of the vehicle sampled over a time period,
at least one GPS receiver for measuring the location of the vehicle,
a computer comprising memory and a processing unit, configured for executing the method as herein described for assessing the condition of said vehicle.

The systems and methods disclosed herein may in particular be applied to vehicles and described above, but they may also be applied to equipment, machinery and/or parts in general. Employing the herein described system and method for monitoring equipment and machinery may lead to a functional implementation of predictive maintenance. Once operational the next step may be reliability (or risk) centered maintenance (RCM), where the equipment is scheduled for maintenance based on monitoring the condition and what the users require in the present operating context. Compared with predictive maintenance, RCM may further reduce maintenance cost and increase fleet reliability and availability. The presently disclosed system and method may also help to prevent misuse of machinery by ensuring that the each unit in a fleet is operated within predefined operational limits, e.g. in terms of wear, speed, surface, etc. It may also help to improve safety for the drivers that can be warned of potential hazards before they occur, because the condition of the vehicles is monitored.

This monitoring may be provided in each vehicle and also centrally monitoring the entire fleet.

### DESCRIPTION OF DRAWINGS

FIG. 1 shows one embodiment of a vehicle monitoring system according to the present disclosure.

FIGS. 2a and 2b illustrate the definition of the angular orientations pitch, roll and yaw.

FIG. 3a illustrates an example of a classification of data based on z-acceleration data.

FIG. 3b shows an example of a decision tree used for classification of data.

FIG. 4a shows x- and y-acceleration data for use in a reference model.

FIG. 4b shows the dataset in FIG. 4a with the principal components as a result of a PCA of this dataset in FIG. 4a.

FIG. 4c is like FIGS. 4a and 4b with the addition of a 2D normal reference ellipsoid generated from the principal components.

FIG. 5a shows the reference ellipsoid from FIG. 4c with new data points acquired from a new tour.

FIG. 5b shows the ellipsoid that is generated from a PCA of the new data in FIG. 5a compared to the reference ellipsoid from FIG. 4c.

FIG. 6a: The image shows a reference model ellipsoid 61 (depicted in solid yellow) which is computed from hours of x, y and z acceleration data acquired from a single vehicle. An ellipsoid model 62 computed from the data of a single short tour is shown in green. The short tour was performed in a careful driving style.

FIG. 6b: The image shows a reference model ellipsoid 61 (depicted in solid yellow) which is computed from hours of x, y and z acceleration data acquired from a single vehicle. An ellipsoid model 63 computed from the data of a single short tour is shown in red. The short tour was performed in an aggressive driving style.

FIG. 7a: The images shows a 3D reference model ellipsoid 71 in transparent yellow computed from x, y and z acceleration. An ellipsoid model 72 computed from a single tour is shown in red.

FIG. 7b: The image shows the individual measurements of the x-, y-, and z-accelerations of a single tour. Each point is one such measurement. All measurements which are inside the 99.5% reference ellipsoid have been removed—the reference model ellipsoid is not shown. The points shown are those which are considered to be extreme or outliers. It is clearly seen that these measurements form two major clusters 74, 75 located on the diagonal of the y- and z-axes.

FIG. 8 shows the generation of a Wohler curve for estimation of wear.

FIG. 9 shows one embodiment of the herein disclosed monitoring system.

FIG. 10 shows an example of a monitoring system in the context of difference reference models.

FIGS. 11a-c show ellipsoid models generated from x, y, and z acceleration data acquired during slow, normal and fast drives.

FIG. 12a shows x, y and z acceleration data acquired from a vehicle during a short turn.

FIG. 12b shows roll, pitch and yaw, i.e. angular orientation, acquired from a vehicle during the same period as in FIG. 12 a, i.e. during a short turn.

FIGS. 13-17 show the same three second time window acquired from a vehicle during a left turn. FIGS. 13a-17a show x, y and z acceleration, FIGS. 13b-17b show speed along the x-direction and x and y acceleration along the y and z axes, respectively, and FIGS. 13c-17c show roll (x), pitch (y) and yaw (z). FIG. 13 shows both datapoints and corresponding three second status ellipsoid and reference ellipsoid models, in FIG. 14 the three second status ellipsoid model is hidden, in FIG. 15 the reference ellipsoid is also hidden, in FIG. 16 only data points outside the reference model is shown, and in FIG. 17 only the data points outside the reference model is shown along with the reference ellipsoid model.

### DETAILED DESCRIPTION OF THE INVENTION

The “vehicle” as referred to herein may be machinery in general, in particular vehicles used for transport or movement of personnel or goods, such as vehicles on tracks and wheel, such as trains, cars, trucks, off-road vehicles, military vehicles, motorcycles, helicopters, planes, harvesters, combat vehicles, and equipment like excavators, forwarders, loaders, tractors, harvesters. But also other types of machinery, e.g. stationary machinery that does not change location geographically but have moving parts that needs maintenance and which can be monitored, such as wind turbines, etc.

### Eigen-Decomposition

Eigen-decomposition, or sometimes spectral decomposition, may be seen as the factorization of a matrix into a canonical form, whereby the matrix is represented in terms of its eigenvalues and eigenvectors. Only diagonalizable matrices can be factorized in this way. The eigen-decomposition of a symmetric positive semidefinite (PSD) matrix yields an orthogonal basis of eigenvectors, each of which has a nonnegative eigenvalue. The orthogonal decomposition of a PSD matrix is used in multivariate analysis, where the sample covariance matrices are PSD. This orthogonal decomposition is often referred to as principal components analysis (PCA). PCA studies linear relations among variables. PCA is performed on the covariance matrix or the correlation matrix (in which each variable is scaled to have its sample variance equal to one). For the covariance or correlation matrix, the eigenvectors correspond to principal components and the eigenvalues to the variance explained by the principal components. Principal component analysis of the correlation matrix provides an orthonormal eigen-basis for the space of the observed data: In this basis, the largest eigenvalues correspond to the principal components that are associated with most of the covariability among a number of observed data.

Principal component analysis (PCA) is thus one of several eigenvector-based multivariate analyses, where a statistical procedure uses orthogonal transformation to convert a set of observations of possibly correlated variables into a set of values of linearly uncorrelated variables (the principal components in PCA). This transformation is defined in such a way that the first principal component has the largest possible variance (that is, accounts for as much of the variability in the data as possible), and each succeeding component in turn has the highest variance possible under the constraint that it is orthogonal to (i.e., uncorrelated with) the preceding components. For PCA the rank of the data matrix decides the maximal number of principal components. In practice, the variance explained by the first several principal components may take a fairly big percentage of the total variance. Then only the first several principal components may be kept as the extracted new features to be used in the model comparison. PCA can therefore be thought of as revealing the internal structure of the data in a way that best explains the global variance in the data. If a multivariate dataset is visualized as a set of coordinates in a high-dimensional data space (1 axis per variable), PCA can supply the user with a lower-dimensional picture, a projection or “shadow” of this object when viewed from its (in some sense; see below) most informative viewpoint. This is done by using only the first few principal components so that the dimensionality of the transformed data is reduced.

PCA may be seen as equivalent to the following analysis techniques: discrete Karhunen-Loève transform (KLT), the Hotelling transform, proper orthogonal decomposition (POD), singular value decomposition (SVD), eigenvalue decomposition (EVD), factor analysis, canonical correlation analysis (CCA), Eckart-Young theorem, Schmidt-Mirsky theorem, empirical orthogonal functions (EOF), empirical eigenfunction decomposition, empirical component analysis, quasiharmonic modes, spectral decomposition, and empirical modal analysis. The methods and systems employing PCA as described herein may therefore in further embodiments apply the abovementioned, at least partly analogous, analysis techniques to obtain the same results. E.g. PCA is closely related to factor analysis, wherein factor analysis typically incorporates more domain specific assumptions about the underlying structure and solves eigenvectors of a slightly different matrix. PCA is for example also related to canonical correlation analysis (CCA). CCA defines coordinate systems that optimally describe the cross-covariance between two datasets while PCA defines a new orthogonal coordinate system that optimally describes variance in a single dataset.

A PCA transformation is thus a special orthogonal transformation that transforms the data to a new coordinate system such that the greatest variance by some projection of the data comes to lie on the first coordinate (called the first principal component), the second greatest variance on the second coordinate, and so on. Hence, PCA seeks the linear combinations of the original variables such that the derived variables capture maximal variance. The principal components are therefore uncorrelated. Furthermore, the derived principal components sequentially capture the maximum variability among the data vectors thereby providing minimal information loss;

The directions of the eigenvectors indicate the correlation between the measured variables. So they “form new variables” of the form ax+by +cz, where x, y, z, are the measured ones and a, b, c, are constants. The aim of the PCA is to find these new variables and thereby the dependencies between the measured ones. This transformation is defined in such a way that the first principal component has the largest possible variance, and each succeeding component in turn has the highest variance possible under the constraint that it is orthogonal to and thereby uncorrelated with the preceding components. The lengths of the eigenvectors thus indicate the importance of the corresponding variable. Very short eigenvectors may therefore be ignored, which will lead to a reduction in the number of variables to be treated. The choice of the number of components is therefore adaptive, based on the result of the PCA.

Consider a data matrix, X, with column-wise zero empirical mean (the sample mean of each column has been shifted to zero), where each of the n rows represents a sample, and each of the p columns corresponds to e.g. sensor output. Mathematically, the transformation is defined by a set of p-dimensional loading vectors \vec{w}(k)=(w₁ . . . , wₚ)₍ₖ₎ that map each row vector x₍ᵢ₎ of X to a new vector of principal component scores \vec{t}(k)=(t₁, . . . , tₚ)₍ᵢ₎, given by tₖ₍ᵢ₎=\vec{x}₍ᵢ₎·\vec{w}₍ₖ₎ in such a way that the individual variables of t considered over the dataset successively inherit the maximum possible variance from x, with each loading vector w constrained to be a unit vector. Hence, loading vectors of the principal components are the eigenvectors of the variance-covariance matrix X^{T}X of the data matrix X, which is assumed to be centered by columns.

The principal components and the corresponding loading vectors are orthogonal in their vector spaces, and thus uncorrelated in statistics, which means the variance explained by each principal component is only from itself. The information contained in each principal component is not overlapped with the other principal components. So the cumulative variance explained by the first several principal components can be calculated directly by summing up the variance explained by each of them. The orthogonality of the principal components comes from the orthogonality of their loading vectors and eigenvectors with different eigenvalues are therefore orthogonal.

### Reference Modelling

A reference model can be defined in many ways. The reference models are provided as a measure of the normal ranges for the recorded and calculated vehicle parameters. A reference model can be generated for a single vehicle wherein data are acquired during one or more test runs of the vehicle exposing the vehicle to different driving conditions, e.g. road type, driving style etc. This reference model can then be used for this single vehicle but possibly also for the other vehicles of the same type or brand. However, a plurality of reference models obtained from the same type of vehicle can also be combined to compute a reference model for said vehicle type. This may also apply for groups of vehicles, e.g. trucks in general. Additional vehicle monitoring data acquired during a further time period may be added to already computed reference models. I.e. the reference models may be continuously updated as new data becomes available.

The vehicle monitoring data may be sampled with several hundred Hertz and with a plurality of parameters originating from triple-axis proper acceleration, angular orientation, velocity and location/position of the vehicle result in a vast amount of data. Selecting subsets of this data and generating reference models based on these subsets may be necessary to sort and filter the information contained in the acquired data. The subsets may be selected time periods and/or selected parameters, depending on the application.

A reference model can be defined to include a predefined percentage of all observations. This percentage may be at least 90%, 92%, 94%, 95%, 96%, 97%, 98%, 99%, or at least 99.5%. The actual choice depends on the application and the type of data acquired. If an ellipsoid is generated from eigenvectors it may be expanded to include more data to reach this predefined percentage. Thus, a multi-dimensional reference model may be computed by expanding the ellipsoid, preferably equally in all directions, until a predefined percentage of the data parameters of the corresponding subset is contained inside the expanded ellipsoid.

As previously mentioned a reference model may be multi-dimensional. Data acquired from the inertial measurements on the vehicle may be supplied with sensor data from single parts of the vehicle, data from internal electronic control units, etc. I.e. data directly acquired from the vehicle. Reference models may be generated based on any combination of this “internal” vehicle data. Reference models may also be generated from and/or supplied with “external” data from the vehicle, e.g. geodata such as geographical data indicating the location of the vehicle, weather data, consumption of one or more specific spare parts, service intervals, service cost, Other examples of reference model are provided herein, e.g. reference models for wear estimation and incident detection.

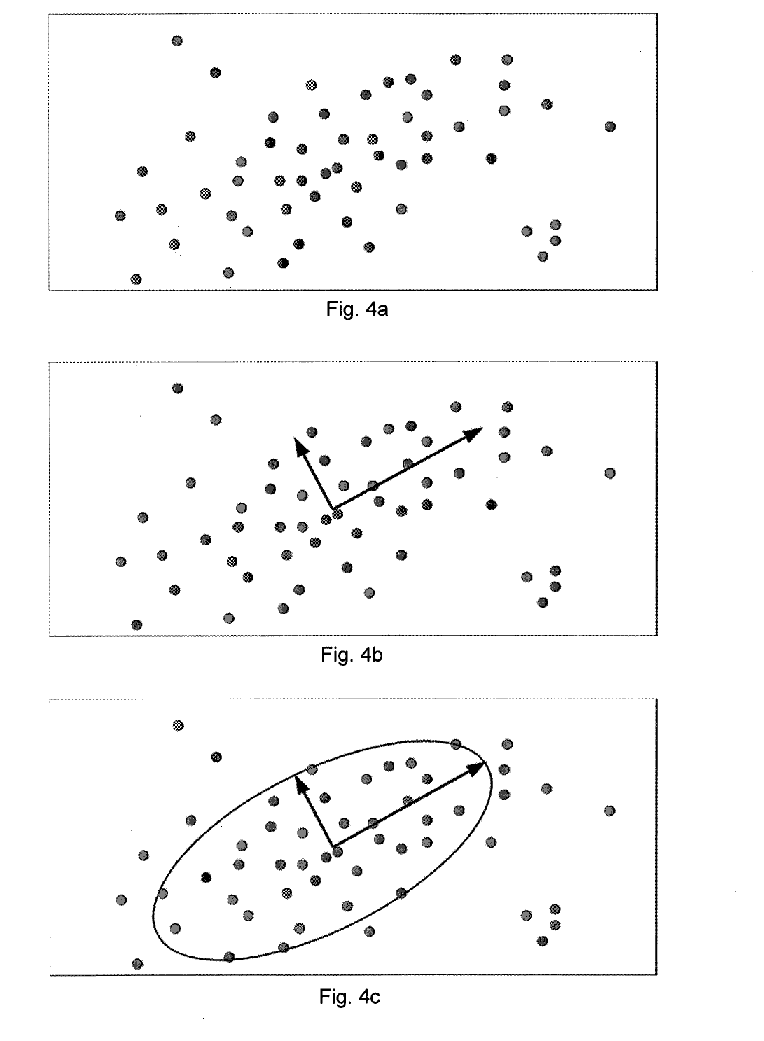

An example of generation of a reference model is illustrated in FIG. 4. FIG. 4a shows the raw data, e.g. x- and y-acceleration data plotted in a x,y coordinate system. A PCA can be applied to these data to calculate the principal components resulting in the linearly uncorrelated eigenvectors illustrated in FIG. 4b. From these eigenvectors a 2D ellipsoid can be generated as illustrated in FIG. 4c where the eigenvectors form the major and minor axis of the ellipse. This ellipse may serve as a reference model, however it may also be expanded to include a larger percentage of the data.

Reference models may be updated along with recording of additional monitoring data. How to incorporate the monitoring data in the updated reference models may be conditioned by analyses of the monitoring data shows how the vehicles adapt to e.g. driver behavior, surface roughness, acceleration and brake profiles, wear calculations, weather, corrective maintenance, repairs, consumption of spare parts, etc. E.g. if. The wear is too high and/or certain repairs are too often, the reference models can be adapted such that the threshold for normal driving is limited.

### Labelling

Subsets may also be selected based on labelling. In general the vehicle monitoring data may be labelled, that is the conditions under which the data has been recorded are known in advance or during recording of the date. Often the data is labelled when processed. Data labelling may be provided manually, but it may also be computer implemented, e.g. by means of a decision tree model, a Bayes classification model or a jump process model. A subset may be labelled, e.g. with respect to driving condition, in terms of:
general condition of vehicle, such as engine off, engine idle, driving
terrain, such as on-road or off-road
road type, such as asphalt, highway, freeway, gravel road, small country road, cobblestone,
off-road type, such as smooth, medium, or rough
geography, such as city, suburban, municipal, countryside,
driver, such as identity, age, gender, nationality or experience,
driving style, such as hard driving style, normal driving style or gentle driving style,
directional movements: x-, y- or z-axis movements,
angular movements: pitch, roll or yaw

Labelled reference models may thereby be provided, i.e. a reference model of a certain vehicle type when driven under rough off-road conditions may be provided. Labels may be combined, such that a reference model of e.g. a young driver in suburban on-road terrain.

Automatic labelling may advantageously be provided when data is collected in short consecutive parts, called chunks. The chunk size s can be selected, e.g. s=60 sec. Given a sampling rate of f Hz, a chunk consists of sf measurements. Every such chunk can thus be labelled, i.e. assigned a label, e.g. in terms of a driving condition which may be more than just the type of surface the tour was performed on. Possible driving conditions include: on-road, off-road as coarse distinctions and freeway, large country road, lesser rural road, farm track, city trip, stop-and-go traffic as examples of more detailed classifications.

### Labelling Example—Idle Detection

The aim is to detect whether the engine is idle or the vehicle is moving. The detection has to work even when the vehicle is placed at an angle or the sensor has a drift. From the vehicle monitoring data a subset of three measure parameters are used:
Acceleration in z-direction
Time
Speed

First the z-acceleration is analyzed and a sequence b₀, . . . , b₁ of bounds is determined. The meaning is: If the span of the z-acceleration is between bᵢ and bᵢ₊₁ then the vehicle is in state i. For example: if the z-acceleration is between b₀=0 and b₁ then the state is S₀=“ignition on, engine off”, if z-acceleration is between b₁ and b₂ the the state is S₁=“engine on and idle”, etc. Let z₀, . . . , zₙ be the original sequence z-acceleration values. The sequence is split into parts with k values each. If k does not divide n, at most (k−1) values are skipped at the end. The average is computed for each part. Let

$${Z}_{0} , … , {Z}_{\frac{n}{k}}$$

denote the sequence of averages. The averaging removes isolated spikes. In the following only the sequence of the averages is used.

Decide a window size ws. Compute the moving minimum, maximum and span for all subsequences consisting of ws values compute for

$$i = 0 , … , ( \frac{n}{k} - ws ) \text{:}$$

min(i)=min({Zⱼ|i≦j≦i+ws−1})

max(i)=max({Zⱼ|i≦j≦i+ws−1})

span(i)=max(i)−min(i)

Traverse the sequence of span(i) values to find maximal intervals were the vehicle is in the same state. The intervals are indicated by the start and end index of the span values; the corresponding times can be computed separately.

The intervals are computed as follows. Determine the current state: if bₘ≦span(0)<bₘ₊₁ set the interval-start to 0 and the current state S_{curr}=m. As long as bₘ≦span(i)<bₘ₊₁, increment i. When for the first time span(i)<bₘ or bₘ₊₁≦span(i) then do the following: Set the interval end to i−1 (the vehicle was permanently in state S_{curr} form interval-start to end), set the new interval-start to i, set the new current state to S_{curr}=m′ where m is such that b_{m′}≦span(i)<b_{m′+1}. The results are consecutive intervals [0, t₁], [t₁+1, t₂], [t₂+1, t₃], . . . such that the vehicle is in the same state for every interval and the intervals are maximal with this property. Using the span removes potential drift in the measurements as well as effects of the vehicle standing at an angle.

A “sanity” check may then be provided: For every interval [tᵢ+1, tᵢ₊₁], check that the the speed values in the interval correspond to the state for the interval. For example, if the state is “idle” then all (or 99.5%) of the speed values in the interval should be close to zero, because the vehicle is at a stand still.

The following table shows the settings for the above mentioned parameters. They have been experimentally determined.

| Parameter | Symbol | Value |
|---|---|---|
| Smoothing window | k | 5 |
| Window size for max, min | ws | 50 |
| Number of idle states | l | 3 (engine stopped, engine idle, |
| | | driving) |

For determining the bounds b₀, . . . , b₁ classified data from test runs was used. For example to determine the state S₁=“engine idle”, 30 min of data was recorded from a vehicle standing still at various places with the engine running idle. On the z-acceleration data the smoothing and the computation of minimum and maximum values described above was performed. From the min(i) values the 0.5% smallest ones was removed. This is to remove disturbances coming from external interference of measurement errors. The value 0.5% is a very safe bet for the data under consideration. Then b₁ is set to the smallest of the remaining 99.5% min(i) values. Similarly, from the max(i) values the 0.5% largest ones were removed. Then b₂ is set to the largest of the remaining 99.5% max(i) values. For the resulting parameter b₀=0 and b₃=09 were chosen, which results in the scheme illustrated in FIG. 2 with “Engine stopped” when acceleration is between b₀ and b₁, “Engine idle” when acceleration is between b₁ and b₂, and “Driving” when acceleration above b₂.

### Labelling Example—Terrain Detection

For a given tour the goal is to identify the driving conditions under which it has been performed. For this example seven measured data parameters are used:
Acceleration in x-, y-, and z-direction
Pitch (p), roll (r) and yaw (d)
Speed

The data from the tour is split into chunks. The chunk size s can be selected, e.g. s=60 sec. Given a sampling rate of f Hz, a chunk consists of s f measurements. Every such chunk will be assigned a label of a driving condition.

For each of the seven parameters the following is computed: The average m_{w} of the absolute values and the variance var_{w} of the original data over the measurements of the chunk, where w is the index of the parameter. If x₁, . . . , xₙ are the observed accelerations in x-direction then

$$\begin{matrix}{m}_{x} = \frac{1}{n} {\sum }_{i = 1}^{n} {x}_{i} & {var}_{x} = \frac{1}{n - 1} {\sum }_{i = 1}^{n} {( {m}_{x} - {x}_{i} )}^{2}\end{matrix}$$

The result is a vector with 15 entries, where the first 14 are the so called attributes and the last one is the classification. All attributes are numerical, actually positive real numbers.

V=(mₓ,m_{y},m_{z},varₓ,var_{y},var_{z},mₚ,mᵣ,m_{d},varₚ,varᵣ,var_{d},mₛ,varₛ;C).

In this example the labelling (or classification) is provided by means of a decision tree model. A decision tree is a rooted binary tree. To each node two items are associated: the index i of an attribute, in this case a number between 1 and 14, and a numerical threshold value t. Informally a node represents a test, where the i-th attribute is tested against the threshold t as follows: Let vᵢ be the value of i-th attribute. Then the test is vᵢ≦t and on continues at the left child node if the test is positive and to right one otherwise.

A gain-criterion is used to build the tree. The input is a set of n training vectors V₁, . . . , Vₙ. At the root node of the tree all attributes is checked to find the one that gives the highest information gain. Informally, this means that an attribute number i and a threshold value t are detected such that there is a class C wherein
The class C is very frequent amongst those vectors with vᵢ≦t and
The class C is very in-frequent amongst those vectors with vᵢ>x

That is, the test vᵢ<t is a “good indication” for membership in class C. The gain criterion selects a good such pair (i, t). Three choices may be tried for t: t₁, t₂, and t₃, where t₁ is such that one quarter of all training vectors have that the attribute vᵢ<t₁. Values x₂, and x₃ of this quantity is one half and three quarters, respectively.

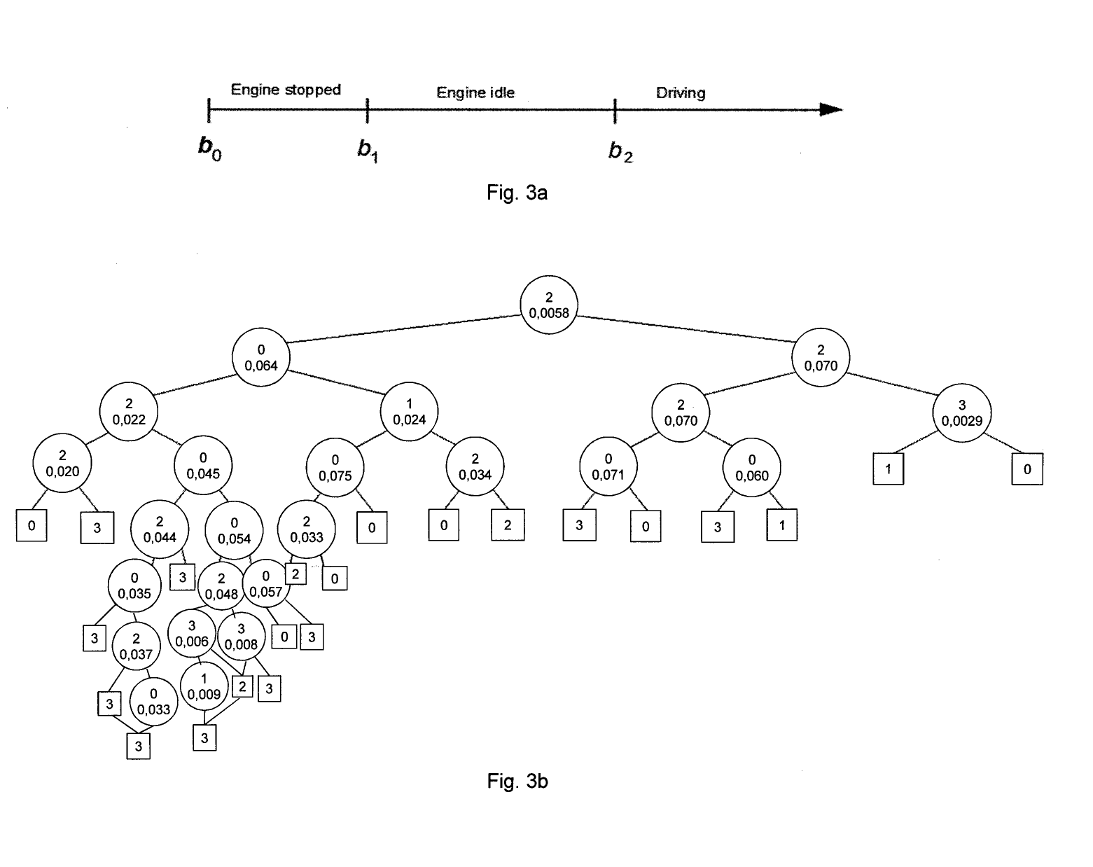

The condition vᵢ≦t is stored at the root. The set of vectors is then split into two sets; one containing all vectors with vᵢ≦t−one with all vectors with vᵢ>t. The root receives two children, one for each of the two set. The sets are then processed recursively at those nodes. The processing stops when the gain is too low or the set of vectors becomes too small. In this case a leaf node is created which contains the classification C which is most frequent in the set. A decision tree is illustrated in FIG. 3.

These vectors can then be used to train and evaluate a decision tree. (For a detailed description of decision trees see for example P. N Tan, M. Steinbach, V. Kumar, “Introduction to Data Mining”, Pearson, 2006.) 80% of the data may be used for training and 20% for evaluation. In order to ensure that all classes are present in the same relation in both training and evaluation data, an 80/20 split is performed per class. The training is run with various selections of the attributes, starting with the full vector of 14 attributes and gradually considering vectors with fewer attributes, like, e.g.,

V=(mₓ,m_{z},varₓ,var_{y},mₚ,varₚ,m_{y},var_{y};C).

Tests showed that using these four data parameters (x-, z-acceleration, yaw and speed gave the best results). This may be natural in that information about the y-axis acceleration, pitch and roll does not provide much information about the terrain that is driven on. The four data parameters result in these eight attributes:

mₓ,m_{z},varₓ,var_{z},mᵣ,varᵣ,mₛ,varₛ

Example of terrain type classification

| T-code | File code | Road type |
|---|---|---|
| T0 | 2000 | City |
| | 2003 | Suburb |
| T1 | 2005 | Smal country road |
| T2 | 2010 | Highway |
| T3 | 2020 | Freeway |
| | 2030 | Copple Stone |
| | Off road | |
| | 2050 | Smooth |
| | 2060 | Medium |
| | 2070 | Rough |

Once a decision tree model has been generated it can be used to classify and label new data. Given a new tour, it is split into trunks in same way as described above. For each chunk, an attribute vector V is computed as described above denoted as V=(a₁, . . . , aₖ), i.e. aᵢ is the i-th attribute. To classify, start at the root of the decision tree, let (i, t) be the attribute index and threshold stored there. Perform the test aᵢ≦t. If the test is true, proceed to the left child of the root otherwise to the right one. Let (i′, t′) be the values stored at the chosen child node. Perform the test a_{i′}≦t′ and proceed as just described. Continue in the same way until a leaf node is reached. Then V (respectively the chunk from which V was computed) is assigned the classification label C which stored at this leaf node.

### Evaluating the Condition of a Vehicle

For both reference models and general monitoring data acquisition may be provided with a predetermined sample frequency of ≧50 Hz, ≧100 Hz, ≧150 Hz, ≧200 Hz, 300 Hz, ≧400 Hz, ≧500 Hz, ≧1000 Hz or ≧10000 Hz. Sample frequencies of 100 Hz or more may be necessary to detect unwanted vibrations in the vehicle or from internal parts of the vehicle.

Data may be pre-filtered during acquisition or during processing to account for extreme outliers, i.e. outliers due to measurements that are obviously wrong or faulty. Pre-filtering may be provided by deleting the outermost 1%, or 0.5%, 0.4%, 0.3%, 0.2%, 0.1%, 0.05% or 0.01% of the data.

When a reference model has been provided the state or condition of a vehicle can be assessed by evaluating whether incoming data is within or outside the reference model that represents the normal condition of the vehicle. Vehicle monitoring data falling outside the reference model may therefore indicate an abnormal condition of the vehicle. This evaluation can be provided in real time or it may be assessed based on data acquired over a time period and post processed centrally, e.g. when monitoring an entire fleet of vehicles.

However, only a few data points outside the reference model may indicate isolated events. Isolated events, i.e. riding over an unexpected bump in the road, can be detected as short-period measurements outside the normal range. Single events may be observed also in the reference models and may be filtered out or deleted.

A general abnormal condition of the vehicle, i.e. a permanent abnormal condition of the vehicle, i.e. not an isolated event or condition, may be when a predefined ratio of one or more of the data parameters of one of the subsets is outside the corresponding reference model. Consequently the severity of an abnormal condition of the vehicle may be based on the ratio of data parameters of one of said subsets that are outside the reference model, i.e. the ratio of data points inside vs. outside the reference model. Further, the severity of an abnormal condition of the vehicle may be based on the distance between the reference model and one or more of the data parameters that are outside the reference model. In case the reference model is an ellipsoid generated from eigenvectors, it may be the distance to the surface of the ellipsoid. E.g. the weighted distance of the outliers, or the distance of the average position of the outliers, etc.

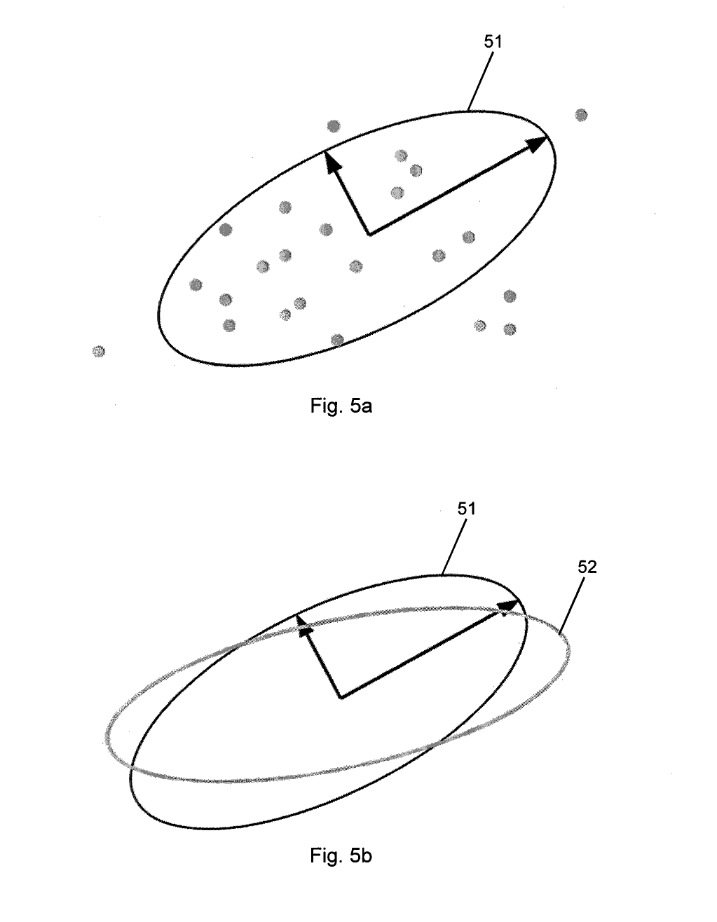

An example is shown in FIG. 5a where the x- and y-acceleration data from a short tour in a vehicle are plotted together with the reference ellipsoid 51 from FIG. 4c. It can be seen from FIG. 5a that the majority of the data points (17) fall within the ellipse 51, however six data points are outside the reference ellipse 51, corresponding to a ratio of 6/23=26% of the data falling outside the reference. This may indicate an abnormal condition of the vehicle.

As stated previously the subsets and/or the reference model may be labelled to provide for a better frame of reference when comparing incoming vehicle monitoring data to a reference model. If the reference model primarily has been generated based on on-road driving and the vehicle is driving off-road, the monitoring data may very likely show a pattern that falls outside the reference model. However, if the reference model is generated from labelled off-road data, the off-road driving is comparable to the labelled reference.

As stated previously vehicle monitoring data may also be processed, real time or offline, by e.g. applying an orthonormal transformation, e.g. a PCA, to provide for a number of eigenvectors. Subsets are selected from for example the three acceleration parameters or the three gyroscope parameters or a combination of those. Multi-dimensional models can be generated from these eigenvectors, e.g. by forming ellipsoids. These multi-dimensional models can then be compared to corresponding multi-dimensional reference models, e.g. also ellipsoids. Visually this can be a very strong tool, because the driving pattern can be directly deduced from the vehicle monitoring data and compared to a reference model representing a normal driving pattern. Visual comparisons are naturally limited to two or three dimensions (see FIGS. 4-6) but model comparisons can mathematically be provided in higher dimensions.

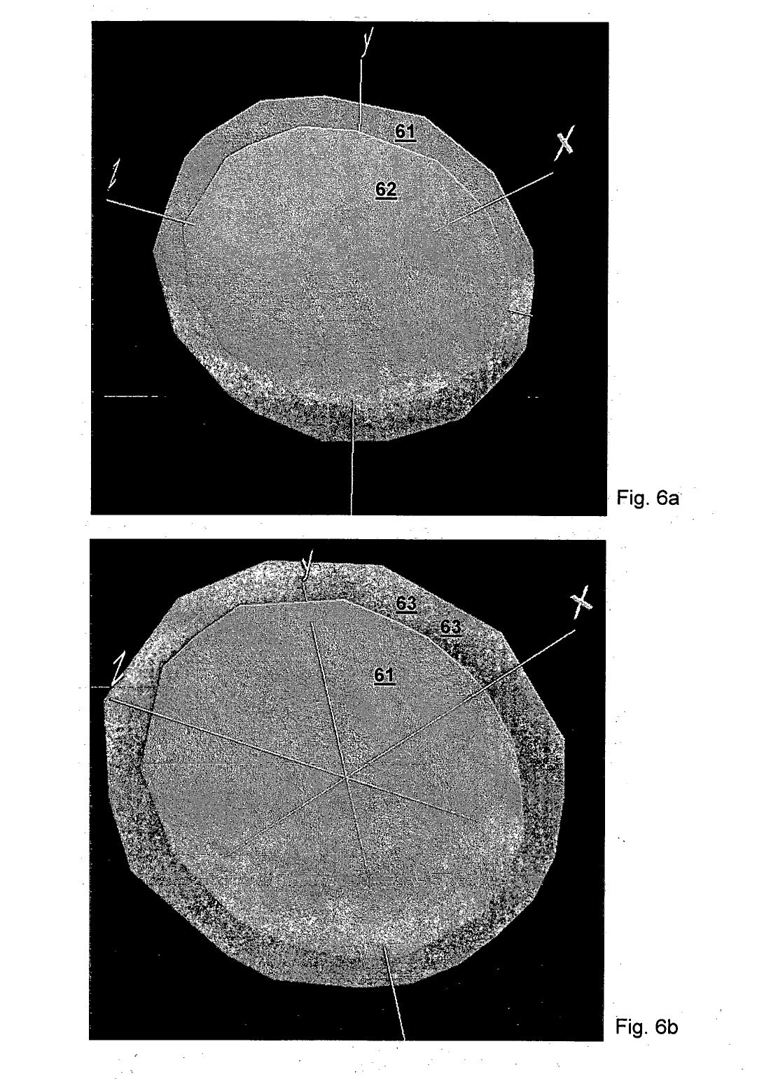

Thus, an abnormal condition of the vehicle may be when the volume of the status model of the vehicle is greater than the volume of the corresponding reference model, see e.g. FIG. 6b. The volumes may be computed in any dimension higher than two. E.g. the volume is greater than a predefined threshold value or percentage. A difference in volume between status model and reference model may indicate an overall difference in strain, e.g. a large strain that the vehicle has been exposed to, or an internal strain of the vehicle due to an abnormality of the vehicle itself.

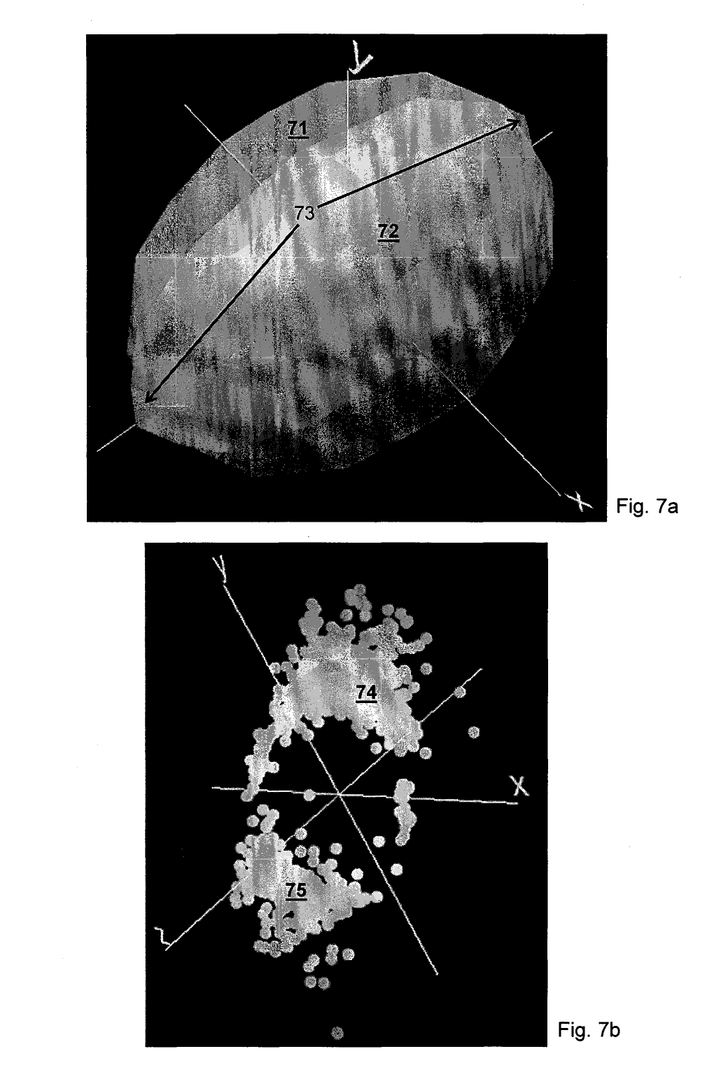

Further, an abnormal condition of the vehicle may be when the length of one or more of the eigenvectors of the status model exceeds the length of the corresponding eigenvector(s) of the reference model. E.g. the volume of the status model may be smaller than the reference model, but the status model may be exceeding the reference model along one or more directions, e.g. in the direction of one or more of the eigenvectors, see e.g. FIG. 7a. E.g. exceeding by a predefined threshold value. Depending on the direction, this can be traced back to, for example, abnormal deceleration/acceleration, abnormally speeds in bends, abnormally high speed on rough roads, etc.

The shape of the status model and the reference model may also differ, e.g. in the form of different elongations of the ellipsoid. This may be expressed as a difference in the ratio of the eigenvectors. Thus, an abnormal condition of the vehicle may be when the ratio of two of the eigenvectors of the status model differs from the ratio of the two corresponding eigenvector(s) of the reference model. E.g. differing, i.e. smaller or larger than a predefined threshold value or percentage. An elongated eigenvector may indicate a stronger-than-normal strain.

Further, an abnormal condition of the vehicle may be when at least a part of the status model diverges from the reference model. E.g. when the direction/orientation of one or more of the eigenvectors of the status model diverges from the direction/orientation of the corresponding eigenvector(s) of the reference model, e.g. diverging by a predefined threshold angle, see e.g. FIG. 5b. A divergence of the directions may e.g. indicate a wrong toe angle or another problem with the suspension. An example of diverging models is illustrated in FIG. 5b, where a condition model ellipsoid 52 has been generated based on the data points shown in FIG. 5a. It can be seen that the two models 51, 52 diverge, this is because the directions of the respective eigenvectors differ. As also indicated above in connection with FIG. 5a this divergence between the condition model and the reference model may indicate a abnormal condition of the vehicle.

In a further embodiment clusters of outliers may be detected, e.g. automatically. An outlier cluster is a group of outliers at roughly the same position/direction outside the reference model. Clusters of outliers may provide additional information and can be used to indicate the source of an abnormal behavior of a vehicle. Thus, the condition of the vehicle can be assessed by detecting outlier clusters of data parameters that are outside of the reference model. An outlier cluster may be defined as a predefined ratio or number of data parameters that are outside of the reference model and located within a predefined angular section. A principal direction and/or angular coordinate of an outlier cluster may be further be determined, e.g. by determining the midpoint of said outlier cluster(s) and determining the direction, such as angular coordinates, of the midpoint.

The basic vehicle monitoring data providing the acceleration, speed, orientation and position of the chassis of the vehicle may be supplied with additional data acquired from the vehicle. Thus, the vehicle monitoring data may further comprise data acquired from one or more electronic control units located in the vehicle sampled over said time period, electronic control units such as the engine control unit, the powertrain control module, the transmission control unit, antilock braking control unit, cruise control unit, or power steering unit. This type of internal vehicle monitoring data may be seen as self-generated data, i.e. data generated by and retrieved from internal components of the vehicle. This may be direct measurements like oil temperature, tire pressure, brake temperature, etc. but it can also be for example alarms and warnings generated by the internal surveillance of the vehicle, i.e. the signal generated when the oil temperature is too high.

This type of internal data generation and acquisition is typically standardised via the CAN bus standard. The vehicle monitoring data may further comprise a plurality of parameters indicative of the movement, acceleration and/or angular orientation of one or more internal moving parts of the vehicle sampled over said time period. Additional data may be processed in the same way as the basic vehicle monitoring data, e.g. generating reference models and status models of the vehicle. However, they may also supply the evaluation of detected abnormalities in the driving behaviour of a vehicle, e.g. when examining isolated events or clusters of outliers or general divergences from the reference models.

Measuring the x-axis acceleration of a moving vehicle can provide information about the total strain from acceleration, e.g. strain on the engine providing the acceleration, and the total strain from deceleration, e.g. the overall strain on the brakes. However, by only having x-axis data, important information may be missing because the additional strain from acceleration and deceleration may be hidden in the y- and z-acceleration data and in data from the angular orientation of the vehicle. The Principal component analysis (PCA) can provide the joint effect of more than one measured variable, resulting in a number of eigenvectors that for example can reveal the true strain exerted on e.g. the engine and the brakes.

For a PCA the following seven basic measured data parameters can be used:
Acceleration in x-, y-, and z-direction
Pitch (p), roll (r) and yaw (d)
Speed

The PCA can be applied to one or more subsets of these parameters to analyze the interplay and joint effect of variables within these subsets. Basic subsets are: the three accelerations or the three rate parameters, however other subsets are possible.

Consider a subset with m parameters X₁, . . . , Xₘ. Assume that there are n observations for each parameter, where those for Xᵢ are denoted by xᵢ₁, . . . , xᵢₙ. Then k-th measurement vector is (x₁ₖ, . . . , xₘₖ). The covariance matrix C can be computed as:

$$C = ( \begin{matrix}cov ( {X}_{1} , {X}_{1} ) & … & cov ( {X}_{1} , {X}_{m} ) \\ ⋮ & ⋱ & ⋮ \\ cov ( {X}_{m} , {X}_{1} ) & … & cov ( {X}_{m} , {X}_{m} )\end{matrix} )$$

$$where$$

$$cov ( {X}_{i} , {X}_{j} ) = {\sum }_{k = 1}^{n} \frac{( {x}_{ik} - {\overline{x}}_{ι} ) ( {x}_{jk} - {\overline{x}}_{j} )}{( n - 1 )}$$

and the mean x̅ₗ is defined by

$${\overline{x}}_{i} = \frac{1}{n} {\sum }_{k = 1}^{n} {x}_{ik}$$

Now compute the eigenvectors v̅ₗ, and eigenvalues λᵢ of C by computing the eigen-decomposition of C (note that C is symmetric and real).

C=QDQ^{T}

The columns of matrix Q are the eigenvectors and the entries of diagonal matrix D are the corresponding eigenvalues. The eigenvectors form an orthonormal system, the longest one pointing in the direction of the “strongest interaction” of the parameters. The lengths are proportional to the eigenvalues and indicate the strengths in the direction of the corresponding vector. For a visual evaluation a geometrical interpretation is most suited. The eigenvectors define an ellipsoid where the vectors form the main axes, cf. FIGS. 4-7 for examples.

The choice of subsets of data parameters depends on the desired result. In relation to the stress imposed on the vehicle, the acceleration values will be of importance. If the focus is on the driving style the gyroscopic data (angular orientation, pitch, roll and yaw) becomes of importance. There is no limit to the number of parameters used in a PCA, however when a visual presentation is wanted, more than three parameters do not make sense.

The PCA approach may for example be applied like this: Training data for computing the PCA reference model is selected. The choice of this data depends on the application.
If data from a number of tours from a single vehicle (or driver) is used to compute the reference model, then this model can later be used to check whether the new tours diverge from the previous ones.
If data form all vehicles of a certain type is used, then the model can be used to detect divergences of a single vehicle from the fleet average.

The PCA model (eigenvectors, eigenvalues, ellipsoid) are then computed. The ellipsoid is “blown up”/expanded, preferably equally in all directions, until a fixed percentage p* of all observation of the training data is contained in the ellipsoid. The choice of the percentage depends on the application, normally p* is in the high 90's. The resulting ellipsoid E* is the normal reference model. A data point (x₁, . . . , xₘ) inside the ellipsoid is considered to be in the normal range, a point outside the ellipsoid is considered out of norm. The distance of the data point to the surface of the ellipsoid can be used to quantify its normality or abnormality.

Given new data, where each data point is of the form (x₁, . . . , xₘ) the analysis proceeds as follows
For every new data point it is checked whether it is inside or outside the ellipsoid E* and the respective percentages pᵢ (ratio of points inside E*) and/or pₒ (ratio of points inside E*).
If pᵢ<p* then the new data has fewer observation in the normal area than expected by the normal model E*.
The distance of the outside data points to the ellipsoid E* gives a quantitative indication of the divergence of the new data form the norm.
The direction in which the outside points are located gives an indication of the cause of the divergence from normal.
Often the outside points are not distributed evenly but they cluster at a few locations. Identifying these locations, gives insight in what caused these extreme observations.

Another approach is not to consider all new data points individually, but instead compute a PCA model (ellipsoid) Eₙ for the new data. The volumes of E* and Eₙ can then be compared to check whether one ellipsoid (e.g. Eₙ) is contained in the other (e.g. E*) or whether the ellipsoids diverge from each other or have significantly different shapes, e.g. ratio between ellipsoid radii.

The methods described herein can be used as “standalone”, but it often makes sense to combine their outputs to derive interpretations at a higher level of abstraction. An example: The vehicle condition assessment method might identify a certain tour as being rougher than average, e.g. the resulting ellipsoid is much larger than the reference ellipsoid. When the terrain detection (i.e. labelling/classification) reveals that the tour was performed on a dirt road or on cobblestones, then the roughness is unavoidable. If the terrain detection reveals that the tour was on a motorway, than the driver really drove unnecessary hard. Other combinations can be imagined. Combination may also be applied as sanity checks, but mostly to achieve more precise interpretations at a higher level of abstraction. In order to automatically derive such high-level interpretations, “intuition” may be applied when selecting and combining the methods. However, as experience has shown important features are often missed which are not immediately obvious. Therefore, Machine Learning techniques may be employed in a further embodiment of the herein disclosed methods. In this case the focus is on “unsupervised” learning; that is no a-priori knowledge is provided. Typical examples that may be applied are cluster analysis and Reinforcement Learning.

### Sparsity

A particular disadvantage of ordinary PCA is that the principal components are usually linear combinations of all input variables and the loadings are typically nonzero. This can make it difficult to interpret the derived principal components. Sparse PCA overcomes this disadvantage by finding linear combinations that contain just a few input variables. Sparse PCA extends normal PCA for the reduction of dimensionality of data by adding sparsity constraint on the input variables. Sparse PCA is an example of a sparse transformation.

Typically the loading vectors from principal component analysis are not sparse. To be more specific, there might be small but non-zero loading coefficients for less important features. A comparison of the magnitude of the coefficients in the loading vectors may help to compare the importance of different features. So, in practice and in some situations, the interpretability of principal components becomes more difficult when the number of features increases and most of the loading coefficients are small but nonzero.

An orthogonal transformation and eigen-decomposition in general, and thereby principal component analysis, is in nature a method for linearly extracting new latent features from the given features, and thus for lowering the dimension of the given features. Sparsity is added to the loading vectors in the sparse version of the principal component analysis. The first motivation to make the loading vectors sparse is that sparse loading vectors are easy to interpret, to observe and to measure. This is especially true in the high dimensional settings where the number of features observed p is comparable to the number of observations n, or even larger than n. In such cases, the high dimension increases the difficulty of the further analysis of the data.

Hence, it is the large number of features that makes it difficult to estimate the true component by the principal component analysis. Then it is important to have sparse loading vectors such that irrelevant and unimportant features are not considered in the estimated principal components.

An algorithm of feature extraction always pursues a transformation by which it transforms data at hand to some new data. The new data are called latent features, latent variables or extracted features. The procedure of exploring a sound and robust transformation is the most important step because the transformation is supposed to better reflect the patterns in the data than the data itself does such that the extracted new data are useful. Sparsity of the loading matrix of principal components is therefore desirable. The sparsity of the loading vectors improves the parsimony of the extracted information contained in the principal components and provides a simultaneous variable selection. The greatest strength of sparse principal component is the easier interpretability. When forcing less influential factors to have no influence on principal factors, sparse PCA (SPCA) automatically wipes off factors that are not of interest. However, at the same time, the following three properties will not hold simultaneously for principal components obtained by SPCA:
maximal variance;
independence of principal components;
independence of loadings.

Whereas feature extraction methods like PCA provides the internal structure of the data in a way that best explains the global variance in the data, sparsity can be a way to reveal local variance in the data thereby extracting other features or additional features of the data. As stated above this “local” information is provided possibly at the expense of independence of the loading vectors. Hence, SPCA may result in that the loading vectors are not orthogonal and consequently the principal components are possibly not uncorrelated in SPCA.

SPCA can for example be provided by the following: Consider a data matrix, X, where each of the p columns represents an input variable, and each of the n rows represents an independent sample from a dataset. It can be assumed that each column of X has mean zero (this can be provided by subtracting a column-wise mean from each element of X). Let Σ=X^{T}X be the empirical covariance matrix of X, which has dimension p×p. Given an integer k with 1≦k≦p, the sparse PCA problem can be formulated as maximizing the variance along a direction represented by a vector vε□^{p} while constraining its cardinality: max(v^{T}Σv) subject to ∥v∥₂=1 and ∥v∥₀≦k.

The first constraint specifies that v is a unit vector. In the second constraint, ∥v∥₀ represents the L0 norm of v, which is defined as the number of its non-zero components. So the second constraint specifies that the number of non-zero components in v is less than or equal to k, which is typically an integer that is much smaller than dimension p. The optimal value of max(v^{T}Σv) subject to ∥v∥₂=1 and ∥v∥₀≦k is known as the k-sparse largest eigenvalue.

In the situation of k=p, the problem reduces to the ordinary PCA, and the optimal value becomes the largest eigenvalue of covariance matrix Σ. After finding the optimal solution v, covariance matrix Σ can be deflated to obtain a new matrix Σ₁=Σ−(v^{T}Σv)vv^{T}. This process can be iterated to obtain further sparse principle components. However, the above mentioned maximization problem is difficult to solve exactly, in particular when the dimension p is high. Various alternative approaches have therefore been developed to solve or approach a solution to the problem, see e.g. Zou et al.: “Sparse Principal Component Analysis”, Journal of Computational and Graphical Statistics, Vol 15, No 2, pp 265-286.

The loading vectors extracted from a sparse transformation can be seen as the extracted features. When performing a sparse transformation to obtain a reference model the resulting loading vectors are the extracted features whereupon the reference model is based. In normal PCA the eigenvectors are orthogonal and a reference model is easily generated and also visualized, e.g. as an ellipsoid. In a sparse transformation the extracted features in the form of loading vectors are not necessarily orthogonal. However, a reference model can for example be generated by distributions, such as statistical distributions, such as Gaussian distributions, of the reference data based on these loading vectors, and the reference model can be defined to comprise a predefined percentile of the reference data. When generating status models from sparse transformations of the monitoring data, the resulting loading vectors can likewise form basis for status models in form of statistical distributions based on the monitoring data and the resulting loading vectors, distributions similar to the distributions for the corresponding reference models. Like the case for normal PCA as described herein, an abnormal condition of the vehicle/machinery, such as anomalies, incidents and unusual driving, can be quantified by differences between the loading vectors and the corresponding reference and status model distributions. Hence, reference models and status models as used herein may be calculated by means of one or more orthogonal transformations as well as one or more sparse transformations.

Estimating Load and Wear The monitoring data from the vehicle may also be used for evaluating the load applied to the vehicle and/or selected parts of the vehicle. Many parts of a vehicle are subject to cyclic loading and monitoring of this load makes it possible to determine the total load and thereby estimate the fatigue life of the vehicle or selected parts (or materials) of it. Damages due to long term use of a structure are often associated with fatigue failure, which is a failure mode that occurs when a structural member has been exposed to a repeated loading a critical number of times. Fatigue performance or fatigue strength can e.g. be characterized by an S-N curve (also known as a Wöhler (or Wohler) curve), which is a graph of the magnitude of a cyclic stress (S) against the logarithmic scale of cycles to failure (N). A Wohler curve maps the number of cycles of a given amplitude it takes to brake a material. Various methods are known in the art to e.g. estimate the influence of the mean stress on the fatigue strength.

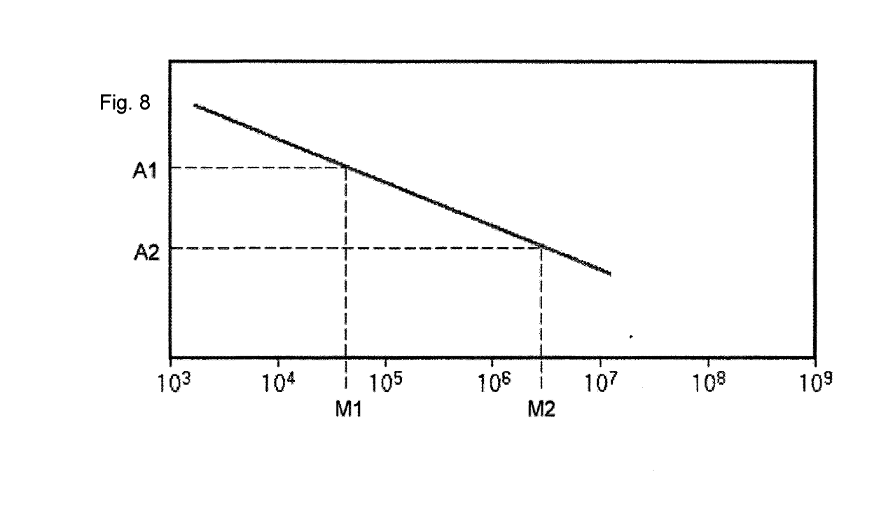

The amplitude as a function of critical number of cycles can be estimated by an exponential function of the form:

$${N}_{i} = {( \frac{{S}_{0}}{{S}_{i}} )}^{m}$$

where Nᵢ is the critical number of cycles of amplitude Sᵢ, and m is the slope of the curve. Hence, the “fatigue strength” of a material can be described by a four parameter model from only a few experiments. FIG. 8 shows a Wöhler curve plotted on a log scale.

An S-N curve is normally generated by subjecting a structure to a cycling constant amplitude loading (usually 1 Hz) until it breaks. Two points are then in theory sufficient to estimate the linear Wohler curve. Hence, with the Wohler curve in hand it can predicted how many more constant amplitude cycles a structural member can withstand if it is know how many constant amplitude cycles it has already been exposed to. The damage to the structure exposed to constant amplitude loading can be calculated as:

$${d}_{i} = \frac{{N}_{i}}{{M}_{i}}$$

Where dᵢ is the damage, Nᵢ is the number of applied cycles and Mᵢ is number of cycles to failure at an amplitude Sᵢ. However, in real life a structure is exposed to excitations of varying amplitudes. The number of cycles of different amplitudes in a load signal can be estimated using cycle counting, e.g. rainflow counting. Cycle counting yields a histogram of the cycles binned according to amplitude. It is then assumed that the total damage to a structure can be estimated using Miners rule as:

$$D = {\sum }_{i = 1}^{n} \frac{{N}_{i}}{{M}_{i}}$$

When D>1 the structure is expected to fail.

The wear of a vehicle that is subject to surface excitation can be estimated in a manner similar to the damage estimation described above. However, cycle counting is not applied. Instead, a Wohler-like curve is defined where the standard deviation of the acceleration is used instead of the cycle amplitude. As for the regular Wohler curve, it is assumed that the wear is additive. Thus, in one embodiment the underlying Wohler curve gives the critical standard deviation as a function of mileage.

The wear of a vehicle is preferably estimated by comparing to a reference model, which is generated from two points. The first point is defined as:

(A₂,M₂)=(σ(Acc),20,000,000)

where Acc is the acceleration vector, i.e. x, y, z-acceleration, e.g. acquired from one or more vehicles driven in normal operation, preferably for many hours. Thus, if the vehicle is driven at its expected wear rate for 20.000 km, the accumulated wear should yield unity. The second point is defined from the first point, assuming a slope of b=−1 and A₁=4σ(Acc) as:

$${M}_{1} = {{M}_{1} ( \frac{{A}_{1}}{{A}_{2}} )}^{1 / b}$$

The acceleration vector Acc may initially be filtered with a high-pass filter, e.g. with a cutoff frequency of 0.1 Hz.

The wear of a specific monitored vehicle can be estimated from the measured accelerations of the vehicle, and can be calculated for any of the three measured directions (x, y, z) of acceleration. For the overall vehicle wear, the estimation is based on the resulting acceleration, hence, the norm of the acceleration vector. The monitoring data may e.g. be segmented into segments with a length corresponding to a predefined duration, e.g. of 1-10, 10-20, 20-40 or 40-60 seconds, e.g. 3 seconds corresponding to 600 datapoints if the sampling rate is 200 Hz. The wear can then be calculated for each segment. The overall wear and wear rate (wear per distance) can then be calculated by summation of the segment wear. High pass filtering may be applied initially in order to remove any dc and very low frequent accelerations (e.g. <0.1 Hz). If only one sensor is mounted on the chassis of the vehicle, the wear can only calculated for the vehicle as one unit. For every part of the vehicle whereon an acceleration sensor is mounted, the wear and wear rate can be estimated.

### Incident Detection

The orthonormal transformation like the PCA is typically applied to monitoring data to determine abnormal patterns in the driving or behaviour. Incident detection on the other hand is applied to detect isolated incidents that normally clearly exceed normal use. Incidents can be related to e.g. accelerations and angular rates of the vehicle.

For accelerations and angular rates incidents can be triggered (detected) in both negative and positive directions. The magnitude of an incident is defined as the value normalized with the incident threshold value to provide a dimensionless relative parameter where the sign indicated the direction of the incident. Threshold values are provided for both positive and negative directions, e.g. for both positive and negative thresholds for x, y, z acceleration and for pitch, roll, yaw. The positive and negative threshold values may be symmetrical, e.g. xₘᵢₙ=−xₘₐₓ.

The monitoring data may e.g. be segmented into segments with a length corresponding to a predefined duration, preferably on the order of minutes, e.g. 1, 2, 3, 4, 5, 6, 7, 8, 9 or 10 minutes. Incidents can then be detected for each segment by analyzing each segment and identifying values exceeding the threshold values specified in the reference model. If a value is found that exceeds one of the threshold values, an incident is detected. The detected incidents may then be categorized according to their magnitude. The signal with the largest value relative to the threshold value is identified as the signal of the incident. A new incident can preferably not be triggered at least 1 second after a threshold value is exceeded.

The monitoring data, e.g. three acceleration and rate signals, may be high-pass filtered initially, e.g. using a filter with a cut-off frequency of 0.1 Hz, in order to remove any dc content.

A reference model with threshold values can e.g. be generated based on the statistical distribution of acceleration and angular rate peaks in reference data, which is representative for normal use of the vehicle. Peaks of each of the acceleration and angular rate signals (both local max and min) in the reference data can be extracted. The absolute peak values may then be collected in a vector for each of the three acceleration and angular rate axes. The assembled peak vectors may be fitted with a cumulative exponential probability distribution P(acc). The threshold values can then be defined as the peak acceleration giving P(acc)=0.9999. I.e. in that case 1 out of 10.000 acceleration cycles is expected to trigger an incident during normal operation.

### Acceleration Characterization

In a further embodiment the acceleration pattern of the vehicle is evaluated, for example by detecting changes in speed caused by driver action, e.g. throttle or brake actuation. This can for example be used for assessing the driver behavior, component wear and fuel consumption. The acceleration of the vehicle can be provided from the x-axis acceleration component of the monitoring data or it can be provided from differentiation of the vehicle velocity that can be provided from GPS data. GPS data are typically sampled at 1 Hz, i.e. typically a smaller sampling frequency that the inertial measurement data. On the other hand the GPS data may be seen to represent the “true” direction of movement of the vehicle. The true forward acceleration of the vehicle can be provided by including one or more of the y- and z-acceleration components and possibly also the angular rates.

The monitoring data may e.g. be segmented into segments with a length corresponding to a predefined duration, preferably on the order of minutes, e.g. 1, 2, 3, 4, 5, 6, 7, 8, 9 or 10 minutes. The acceleration pattern can then be analyzed for each segment, for example by comparing to a threshold value, e.g. specified in g, e.g. 0.01 g, 0.05 g, 0.1 g, 0.2 g, 0.4 g, 0.5 g, or 0.8 g. The positive and negative accelerations that exceed the threshold value may be integrated separately to yield the total energy applied for braking and speeding up. The integration is preferably performed for each segment. Along with the integration, the accumulated distance and time travelled with positive and negative acceleration, respectively can be calculated. A braking, speed-up, and/or overall acceleration index may be calculated to provide a quantitative measure for the type of driving observed in each segment. The index is defined as the integrated braking, speed-up, and overall acceleration, divided by the time travelled while braking, speeding up and overall accelerating, respectively. The overall index can be interpreted as an indicator for fuel consumption, because large amounts of energy applied for acceleration, yields large fuel consumption. An acceleration characterization may therefore provide one or more of the following calculated parameters for each segment: Acceleration distance, brake distance, brake time, speed-up distance, speed-up time, economical driving index, braking index and speed-up index.

### System

As previously stated a further embodiment relates to a system for incorporation into equipment, such as a vehicle, e.g. in the form of a monitoring system for attachment to a craft/vehicle and for monitoring the condition of said vehicle, comprising at least one inertial measurement unit configured to measure the triple-axis proper acceleration, velocity and angular orientation of the chassis of the vehicle sampled over a time period, at least one GPS receiver for measuring the location of the vehicle, a computer comprising memory and a processing unit configured for executing any of the methods described herein for assessing the condition of said vehicle.

An inertial measurement unit is a sensor unit that is configured to measure velocity, orientation and gravitational forces of a moving object whereto the unit is attached, typically using a combination of movement detectors in the form of accelerometers and gyroscopes.

In general data processing and data analysis is not limited to the use of basic data as input to the model generation. It is also possible to use the results and/or interpretations produced by a first layer evaluation as the input for a second-layer evaluation, which may provide interpretation on a higher level of abstraction. One example is the use of labelled data, where the data first have been classified (and thereby) labelled and secondly reference models and/or vehicle condition models can be generated based on labelled data. A third step may then be to identify outlier clusters and use these as input for further evaluation, e.g. in combination with data from additional sensors on the vehicle or CAN bus data from electronic control units in the vehicle.

The presently disclosed vehicle monitoring system may be configured to provide the condition of the vehicle in real-time, e.g. during driving of the vehicle. This may be employed to provide the driver with real-time information about the vehicle, e.g. by displaying the condition of the vehicle in a display in the vehicle. This may be a strong tool to prevent misuse of vehicles and machinery because the online feedback may ensure that the vehicle is operated within predefined operational limits, limits that may be determined by feeding the appropriate reference model(s) to the monitoring system.

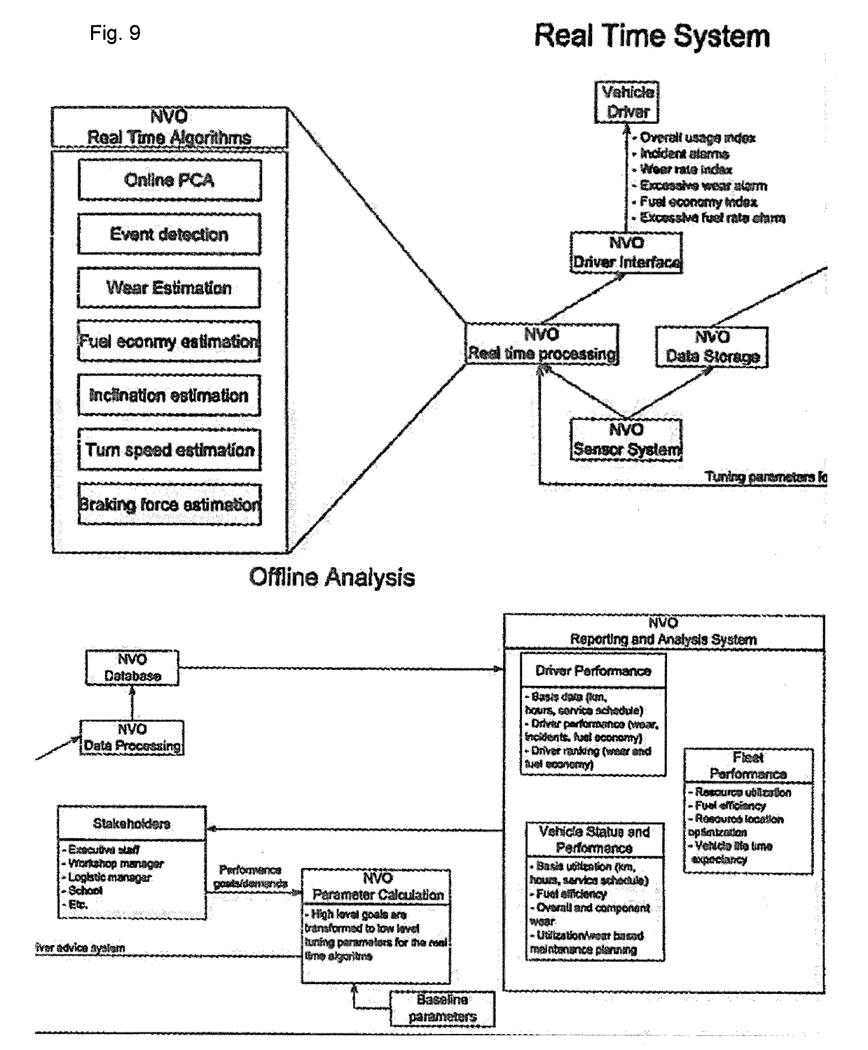

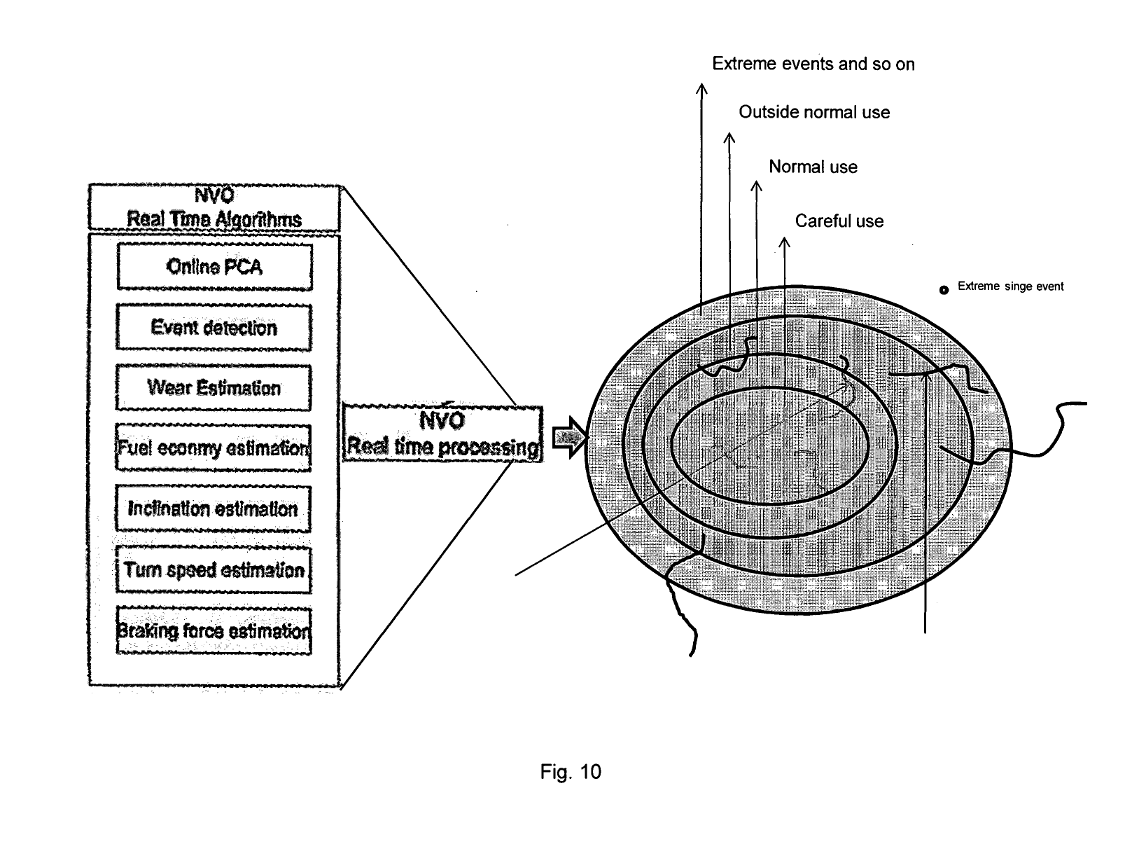

In one embodiment the system comprises three main components; the real time system, the offline analysis tool and the parameter calculation module. The system is illustrated in FIG. 9. The real time system is the system which is installed in the vehicle. The system consists of a sensor module for measuring the herein described monitoring data, a processing module, a local storage module and a driver interface module. The measured data is stored in the local storage module, and processed in the processing module. The processing module may calculate indicators and alarms related to wear, fuel consumption etc. These indicators and alarms can be displayed in real time to the driver by the driver interface module, and indicate to the driver how to change his/her behavior. The calculation of the indicators and alarms are based on vehicle specific threshold parameters. Thus, the parameters are determining at which levels a given alarm or indication is triggered. Hence, the driver behavior can be adjusted by adjusting the parameters, such that a required behavior is achieved. The parameters are fed to the real time system from the parameter calculation module.

The offline analysis system is a tool configured for analyzing single vehicle and vehicle fleet performance. The offline analysis system displays the data that is stored in the database in structured manner. The system enables different stakeholders to assess the performance of the fleet and make operational decisions. A wide range of stakeholders may be using the offline analysis tool, i.e. executive staff, workshop managers, logistic managers, driving instructors etc. Some of the stakeholders will have privileges to request a behavior change, i.e. request a behavior that increases the service intervals. This is done using the parameter calculation module.

The parameter calculation module is configured to translate qualitative behavioral changes requested by the stakeholders to quantitative changes in the parameters that can be fed back to the real time system. The parameter module allows the user to adjust certain performances around a baseline level, i.e. the stakeholder can by increase or decrease the service interval around the baseline level. The system can be configured to immediately show the consequences of one performance change on the remaining performances, i.e. if the frequency of service intervals is increased the expected mean velocity is increased. The required qualitative changes are translated to variations of the parameters that can be fed back to the real time system.

FIG. 10 shows an illustration of the driver and fleet manager advice that can be provided by the presently disclosed system and method. The monitoring system provided vehicle monitoring data that can be analyzed and incorporated into a context of reference models representing different uses of the vehicle, e.g. careful use, normal use, outside normal use and excessive use and extreme events. Different tours or sequences of driving events (indicated by the worm-like lines) can be analyzed in the context of the different reference models. If most of the tour is within the normal use of the vehicle, it can be deemed to be acceptable. However, if most of the tour is outside normal use it may pose a problem.

The system may furthermore comprise a wireless transmitter. This may be provided to transmit the acquired data and/or processed data and/or the condition of the vehicle to a central server and/or database and/or data analysis center. Data may be transmitted continuously or whenever the vehicle is within range of a plurality of hotspots forming a wireless data collecting system. Whenever a vehicle comes close to a hotspot, the data from the vehicles memory is transferred to the hotspot. The data collected by the wireless data collection system may be transferred a database where it may be long-term stored for further handling. The system may further comprise one or more data modelling systems configured to analyze the stored data in the database with respect to different criteria, e.g. vehicle wear, driver performance, fleet availability etc. Each application may require one or more reference models, possibly labelled reference models. Thus, the relevant data may be retrieved from the database for processing.

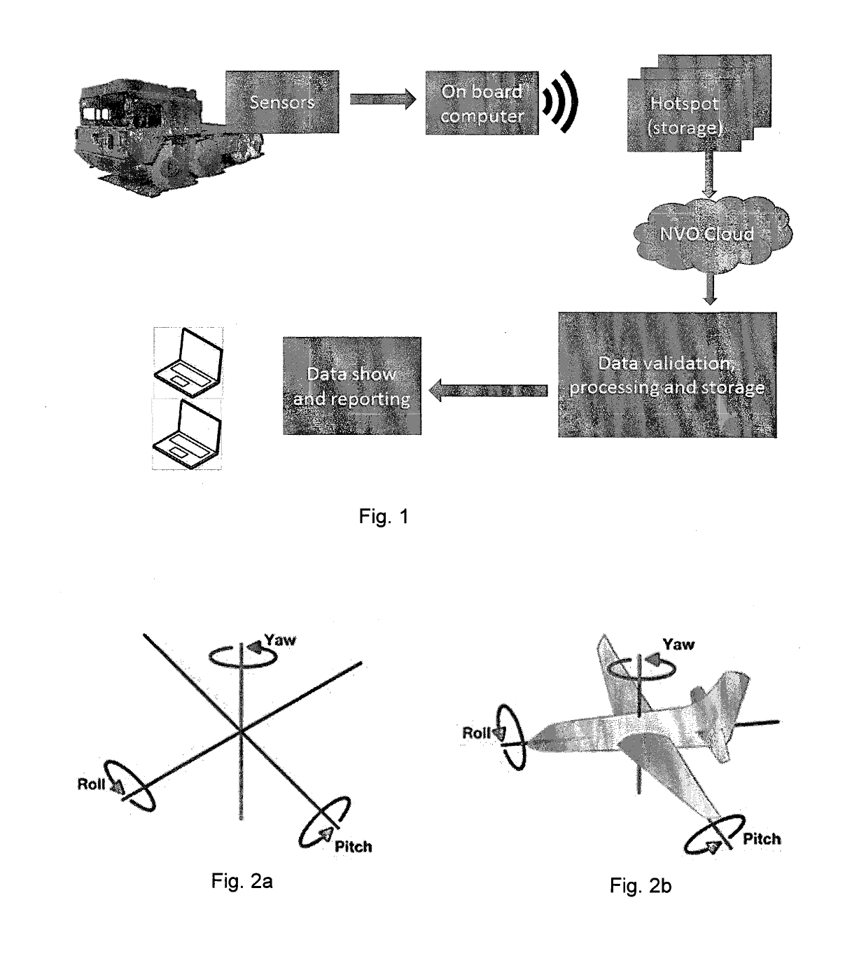

An illustration of an exemplary vehicle monitoring system is illustrated in FIG. 1. The NVO core system comprises the a vehicle unit (VU) comprising a vehicle monitoring system with sensors and an onboard computer including a wireless transmitter for transmitting monitoring data to a wireless data collection system/hotspot storage wherefrom the data is distributed via a cloud service. From the cloud data validation, processing and storage and a number of reference models and vehicle condition models can be computed. Stored data can also be retrieved by a data analysis and interpretation system (DAIS) for generation of models and assessing the condition of the vehicle to provide a result that can be shown to a user. Another option is that the vehicle comprises a vehicle unit (VU) and a DAIS for real-time generation and interpretation of models such that results can be shown to a user in the vehicle, e.g. the driver.

Processing may include analysis, evaluation and interpretation. E.g. a reference model is computed and evaluated against incoming data for online/real-time analysis and/or evaluated against data stored in the database. Evaluations may include statistical analysis of a fleet, a single vehicle or driver or a group of drivers, a specific description of the condition of vehicle, the registration of abnormal events and their severity, and/or a real-time advice to the driver as a reaction to an incident.

In a further embodiment the monitoring system further comprises one or more additional movement detectors, such as accelerometer, gyroscope, or initial measurement unit, mounted on the chassis of the vehicle or on one or more internal moving parts of the vehicle for measuring the movement, acceleration and/or angular orientation of said part(s), e.g. the engine, bearings, suspension, etc. The monitoring system may further be adapted to acquire data from the vehicle's internal electronic control units such as the engine control unit, the powertrain control module, the transmission control unit, antilock braking control unit, cruise control unit, or power steering unit. This type of data acquisition are typically standardised via the CAN bus standard. Other types of input could be video imaging the road or manual input provided by the driver.

The herein described detailed modelling may be more precise if the acquired data can be defined according to the same reference coordinate system. That typically requires a very low drift in the data outputted from the sensors in the car. Drift in orientation typically arises from temperature variations around the sensor. Many consumer electronic devices comprise both accelerometers and gyroscopes, but they also typically account for an unacceptable drift if used for the presently disclosed purpose of vehicle monitoring. The present inertial measurement unit(s) may therefore advantageously be temperature controlled. Further, it may be provided with a static accuracy of ≦±1°, preferably ≦±0.5°, with regard to pitch and/or roll. Furthermore, the inertial measurement unit(s) preferably has a dynamic accuracy of ≦±3°, preferable ≦±2.0° with regard to pitch and roll. Furthermore, the inertial measurement unit(s) furthermore has a repeatability of ≦0.4° or ≦0.3° or ≦0.2°, and/or a resolution less than ≦0.3° or ≦0.2° or ≦0.1°. The long term drift of the present inertial measurement unit is therefore preferably neglectable.

The presently disclosed methods and systems may for part of a new type of monitoring, surveillance and maintenance of machinery which can be termed iHUMS for intelligent health and usage monitoring system. iHUMS can be applied to everything from the single automobile to a large fleet of vehicles or the wind turbines of a wind turbine farm. iHUMS provides three levels of analysis. The first level relates to the single unit which can be monitored by monitoring 1) movement from triple-axis acceleration, angular orientation and optionally velocity and location, e.g. from an external sensor mounted on the unit, 2) internal data provided directly from the unit, i.e. data that is generated by internal sensors of the unit, e.g. CANBUS data, etc., and 3) estimation of load and wear as described previously. Data from 1), 2) and 3) can be assembled and analyzed, e.g. in real time, and features can be extracted to generate status models within 1), 2) and 3) and compared to corresponding reference models within 1), 2) and 3), respectively, showing e.g. normal behavior and anomalies of the single unit.

The second level relates to comparison of data from the single unit across 1), 2) and 3) thereby possibly revealing additional features and patterns across the collected datasets.

The third level relates to comparison of a plurality of units providing surveillance and monitoring of an entire fleet of units. Logistics and maintenance can then be optimized to obtain large cost reductions in the fleet management.

### Examples

The PCA approach has been used to classify single tours and to identify abnormal behavior of a vehicle wherein a vehicle monitoring system was installed. In the example many hours of data were collected from a single vehicle to compute the normal ellipsoid (the reference model) by means of PCA. Subsequently data from a number of short tours (20-60 min each) were acquired, PCA's were applied and the resulting model ellipsoids computed from each short tour were compared with the reference model. The driver had been asked to drive some tours very carefully and smooth, while other tours were driven using a hard driving style (generally, fast, strong acceleration and deceleration and fast through curves). The different driving styles could clearly be automatically identified by the system. FIGS. 6-7 show these results and explain how they were found. The system and method were also able to detect a defect on the vehicle. This defect was unknown to the driver, but was nevertheless sensed by the vehicle monitoring system and revealed by the applied methods as demonstrated below.

FIG. 6a: The image shows a reference model ellipsoid 61 (depicted in solid yellow) which is computed from hours of x, y and z acceleration data acquired from a single vehicle. An ellipsoid model 62 computed from the data of a single short tour is shown in green. The short tour was performed in a careful driving style. This is reflected by the fact that the green ellipsoid 62 is completely contained inside the reference model 61. The difference in volumes between the models can be seen as a measure of how much more careful the short tour was performed.

FIG. 6b: The image shows a reference model ellipsoid 61 (depicted in solid yellow) which is computed from hours of x, y and z acceleration data acquired from a single vehicle. An ellipsoid model 63 computed from the data of a single short tour is shown in red. The short tour was performed in an aggressive driving style. This is reflected by the fact that the red ellipsoid is completely outside the reference model 61. The difference in volumes between the models can be seen as a measure of how much more stressing the short tour was on the vehicle.

FIG. 7a: The images shows a 3D reference model ellipsoid 71 in transparent yellow computed from x, y and z acceleration. An ellipsoid model 72 computed from a single tour is shown in red. Even though the single tour has been performed in a gentle driving style, one can see that the resulting ellipsoid 72 is more elongated in the z-direction that the reference model and even sticks out of the reference ellipsoid in the z-direction. This indicates an abnormal behavior of the vehicle. In this case the abnormality was caused by a defect on one of the tires, causing an increased instability in the z-direction during driving. The next time a tire is defect it may be detected sooner, because the model pattern is now known.

FIG. 7b: The image shows the individual measurements of the x-, y-, and z-accelerations of a single tour. Each point is one such measurement. All measurements which are inside the 99.5% reference ellipsoid have been removed—the reference model ellipsoid is not shown. The points shown are those which are considered to be extreme or outliers. It is clearly seen that these measurements form two major clusters 74, 75 located on the diagonal of the y- and z-axes. These clusters can be defined to be within certain angular section of the x-, y- and z-axes. The clusters of outliers 74, 75 indicate a particular strain in these directions. Further knowledge regarding the cause of this outlier clustering can be provided by e.g. combining with additional data acquired from the vehicle during the same sampling period, e.g. CAN bus data, road type, driver information, etc.

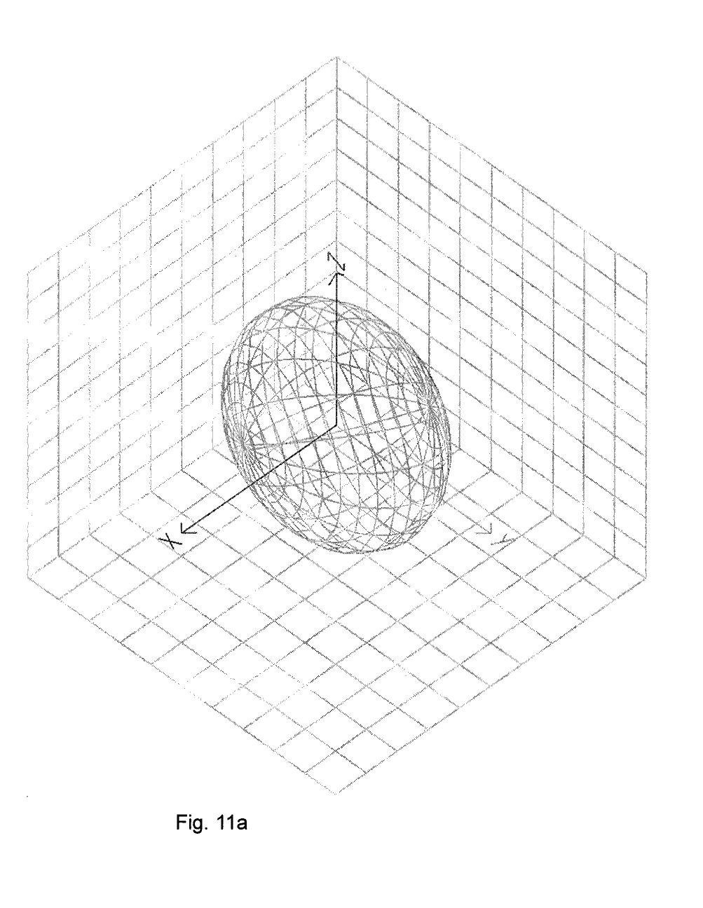

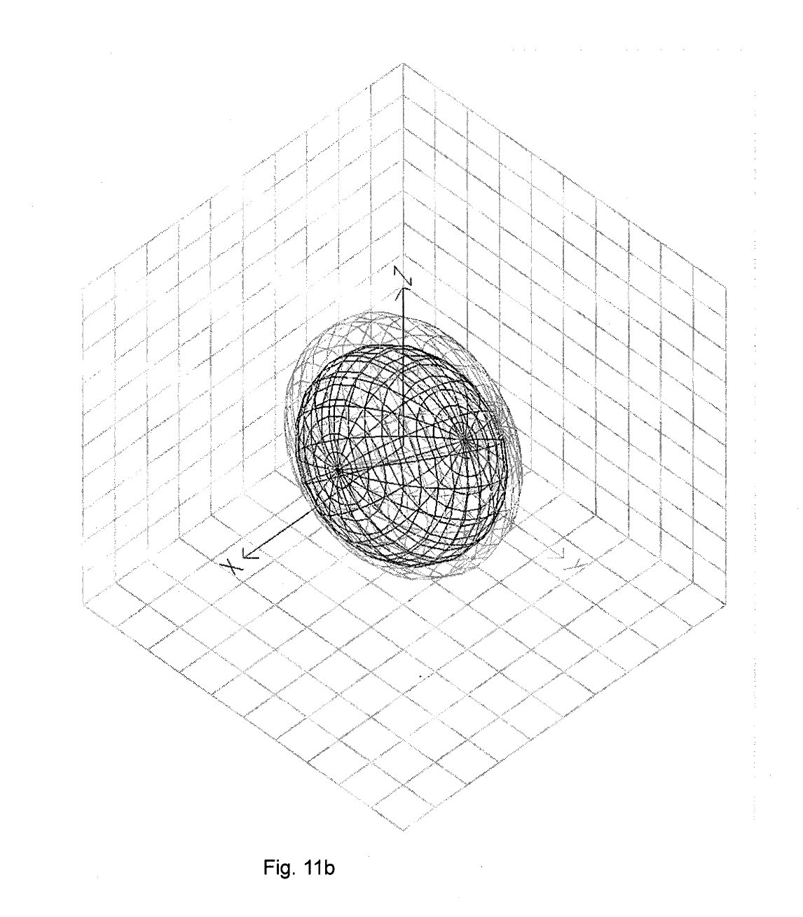

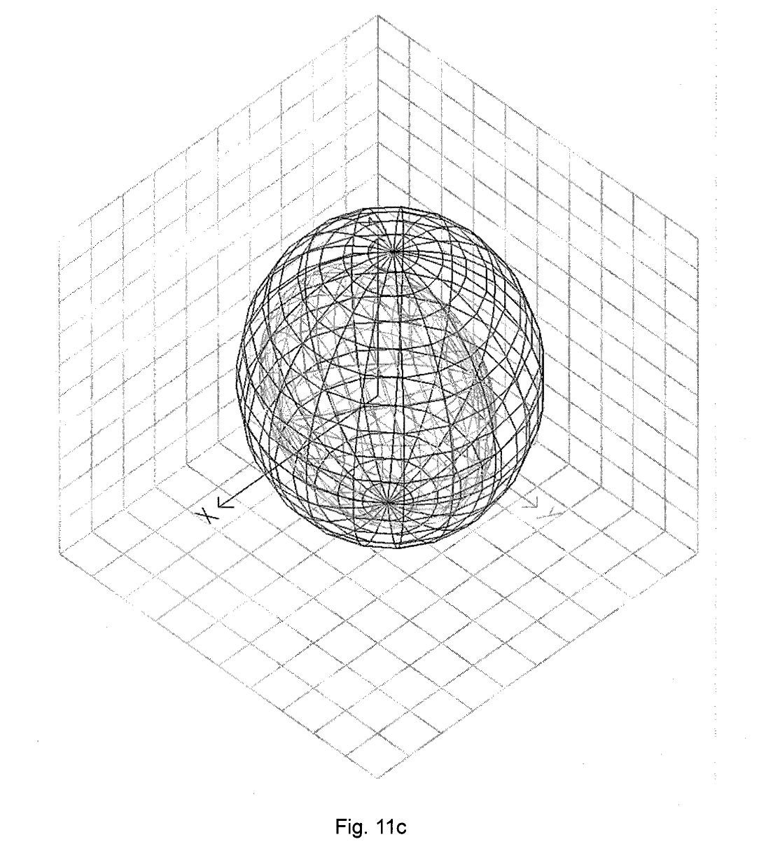

FIGS. 11a-c shows an ellipsoid model (depicted in solid green in all three figures) computed from x, y and z acceleration data acquired from a single vehicle on a normal drive. The ellipsoid is generated such that 95% of the data points are inside the ellipsoid. Only the ellipsoid is shown in FIG. 11a. In FIG. 11b the ellipsoid from FIG. 11a is compared to an blue (darker) ellipsoid computed from x, y and z acceleration data acquired during a slow drive and it can be seen that the blue ellipsoid lies completely within the normal drive green ellipsoid. Correspondingly x, y and z acceleration data has been acquired during a fast drive and the resulting ellipsoid model is shown in red in FIG. 11c. The green normal drive ellipsoid now lies completely within the red fast drive ellipsoid model. FIG. 11 therefore illustrates how easy differences in driving styles can be revealed by means of the presently disclosed systems and methods. These differences can furthermore be quantified by comparing the volumes or the size of the loading vectors of the corresponding principal components.

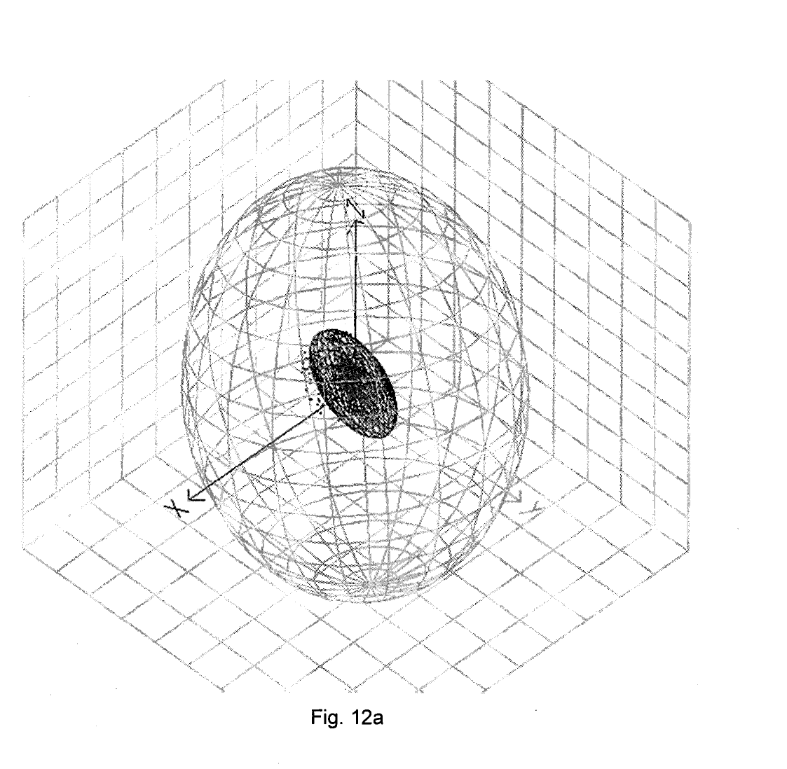

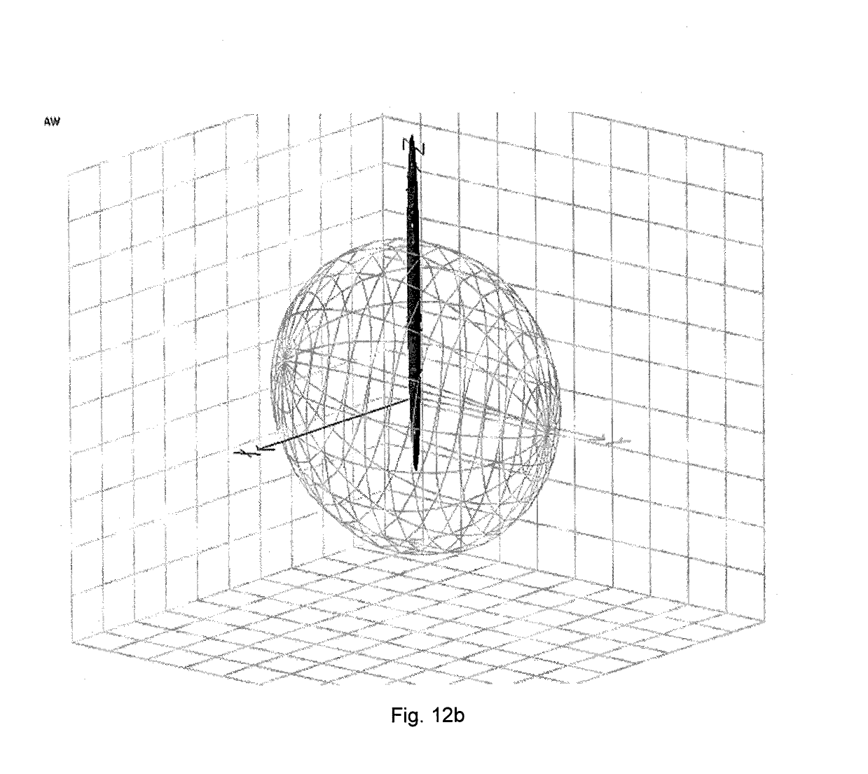

FIG. 12a shows x, y and z acceleration data acquired from a vehicle during a short turn and FIG. 12b shows roll, pitch and yaw, i.e. angular orientation, acquired from a vehicle during the same period as in FIG. 12 a, i.e. during the short turn. The datapoints are included as red points and a blue ellipsoid model is generated including 95% of the data points. FIG. 12a further includes a green reference model showing normal drive. The x, y, and z data in FIG. 12a does not reveal anything unusual and the data lies within the normal behavior for these parameters. However, looking at the angular movements in FIG. 12b the data can be seen to be outside the green reference model. The blue (dark) ellipsoid is an ellipsoid generated from the roll, pitch and yaw data during the pivot turn. The volume of the blue ellipsoid is small but the ellipsoid is long and the relation between the longest and second longest eigenvector is large for the blue ellipsoid. It can further be seen the longest eigenvector is longer than the eigenvector of the reference model revealing an unusual movement during the pivot turn. Such small windows of data, in this case 3 seconds, can for example be subject to online or real-time analysis such that the drive can be warned almost instantly during drive.

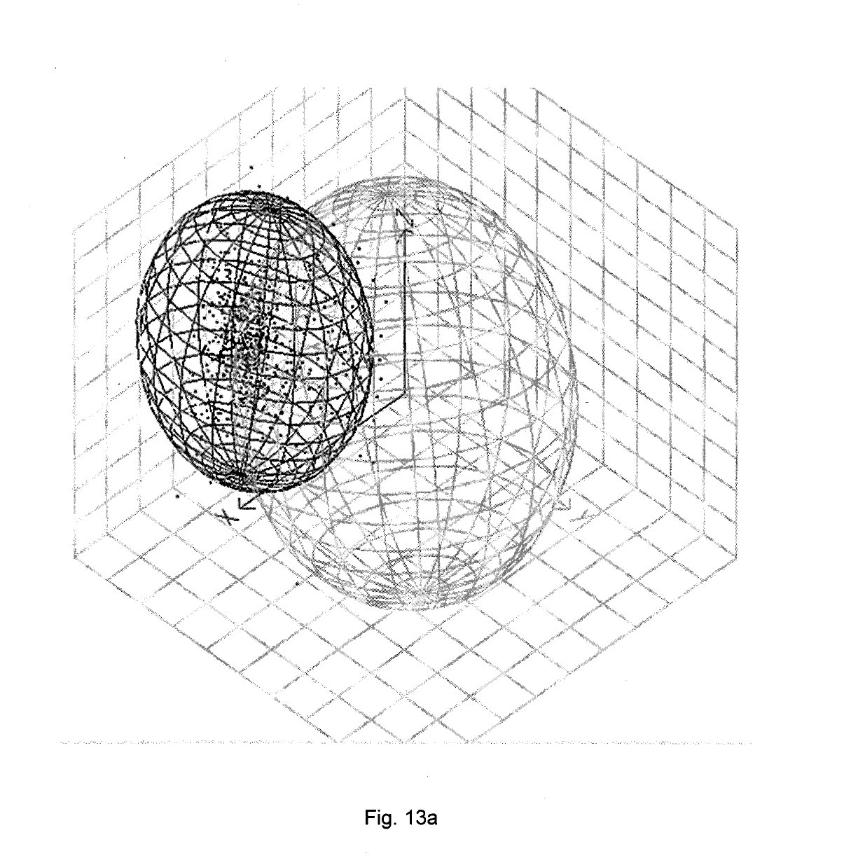

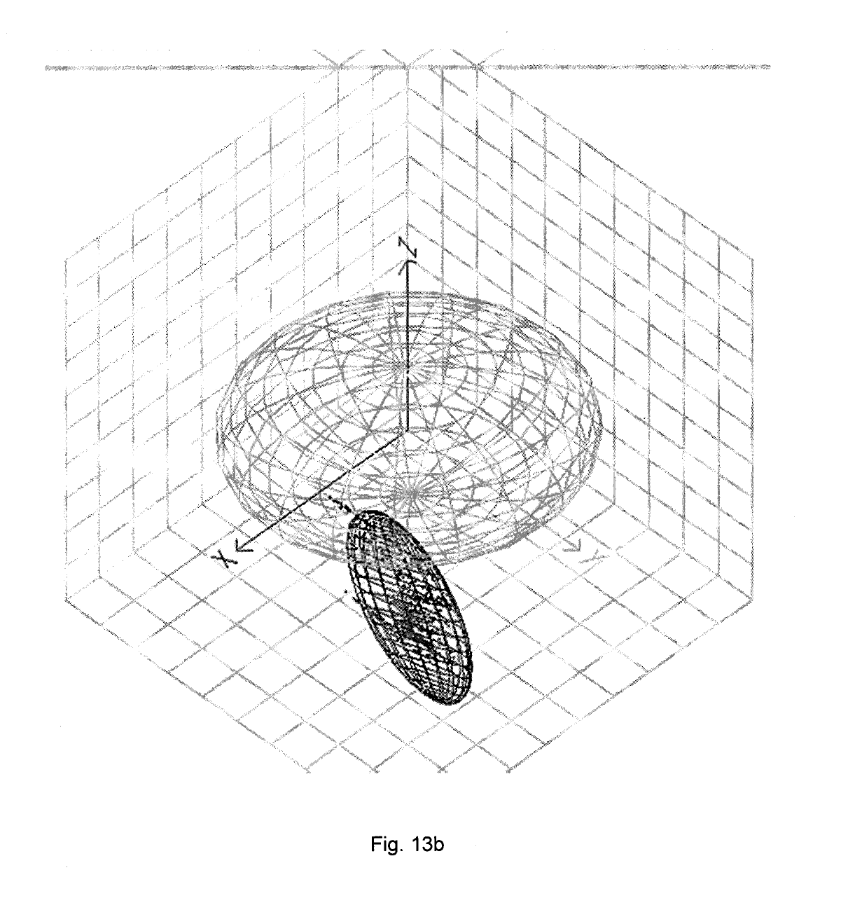

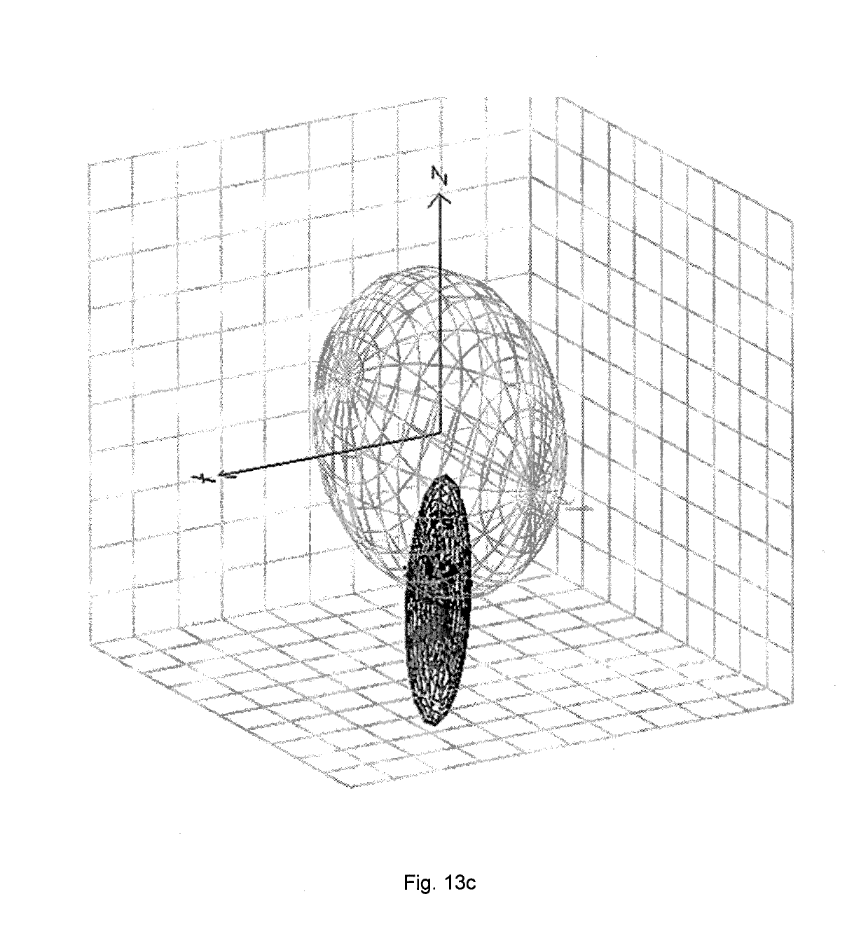

FIGS. 13-17 show the same three second time window acquired from a vehicle during a left turn. FIGS. 13a-17a show x, y and z acceleration, FIGS. 13b-17b show speed along the x-direction and x and y acceleration along the y and z axes, respectively, in the plot, and FIGS. 13c-17c show roll (x), pitch (y) and yaw (z). FIG. 13 shows both datapoints and corresponding three second status ellipsoid models (blue, dark) and a reference ellipsoid model (green, lighter).

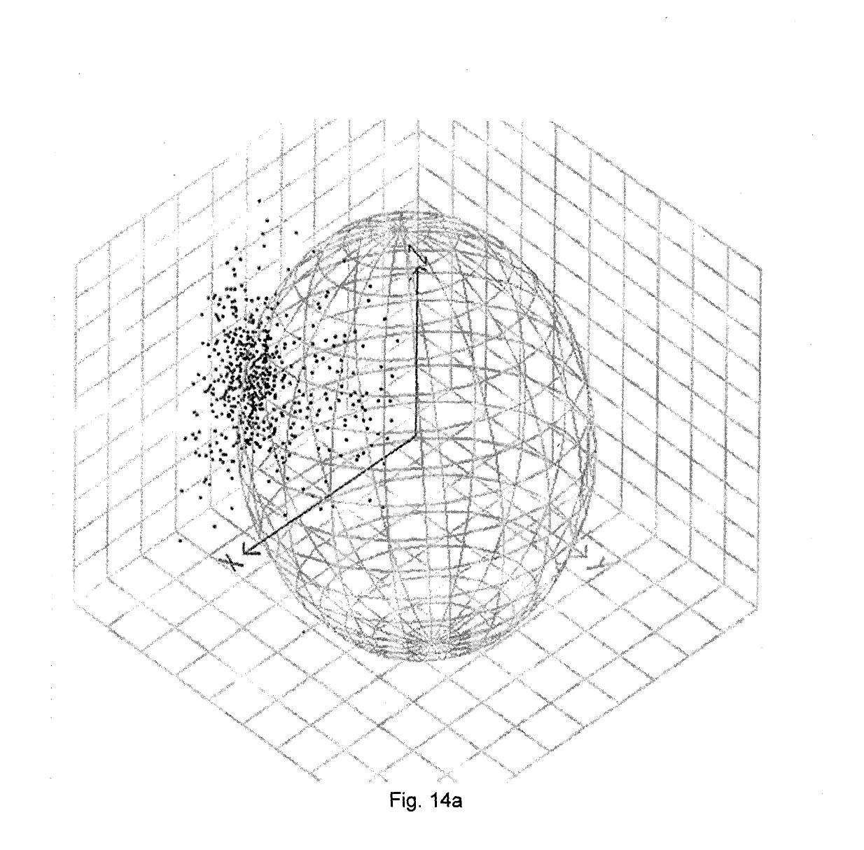

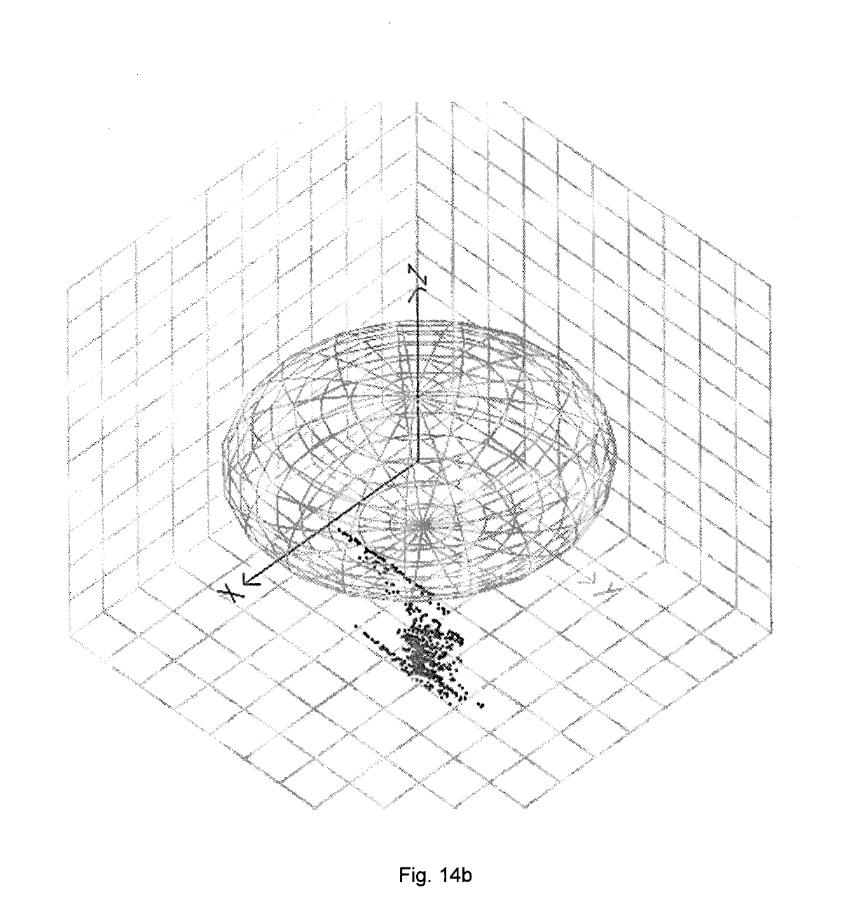

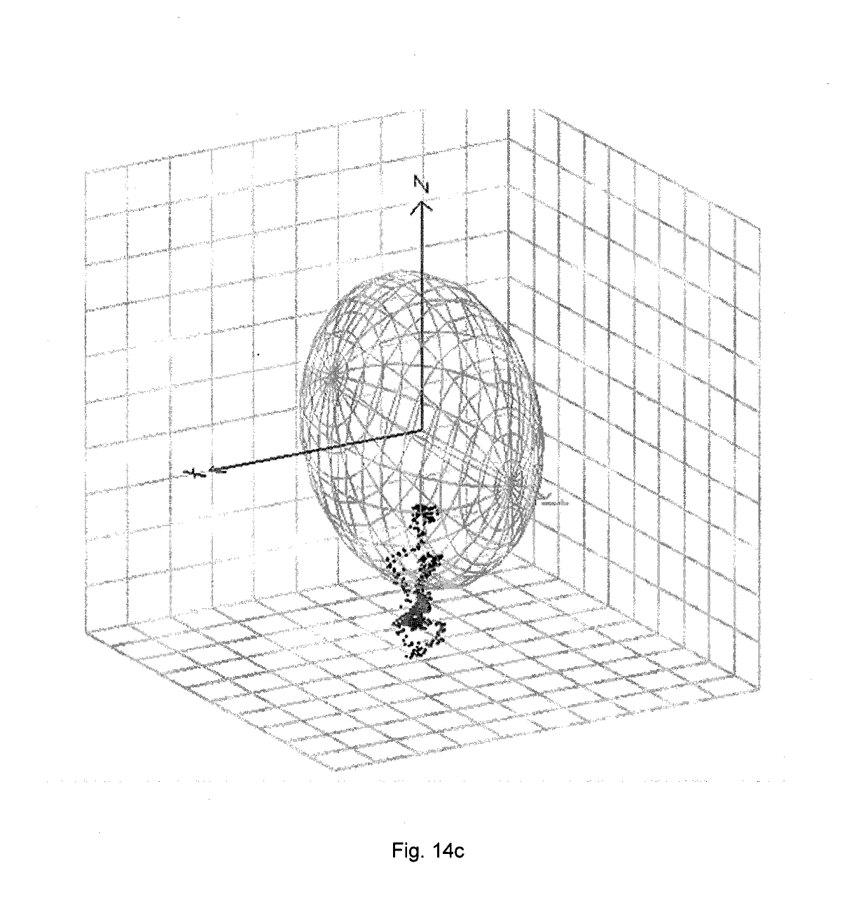

FIG. 14 corresponds to FIG. 13 but the blue status models have been hidden now showing only the data points along with the reference models. Datapoints inside the reference model are black whereas datapoints outside the reference model are red. 600 samples are acquired in total (three seconds with 200 Hz datasampling). In the x, y and z acceleration plots 209 datapoints are inside the reference model whereas 391 are outside the reference model. In the plots showing angular orientation 193 datapoints are inside the reference model whereas 407 are outside the reference model. And in the plots showing speed, only 32 datapoints are inside the reference model whereas 568 are outside the reference model.

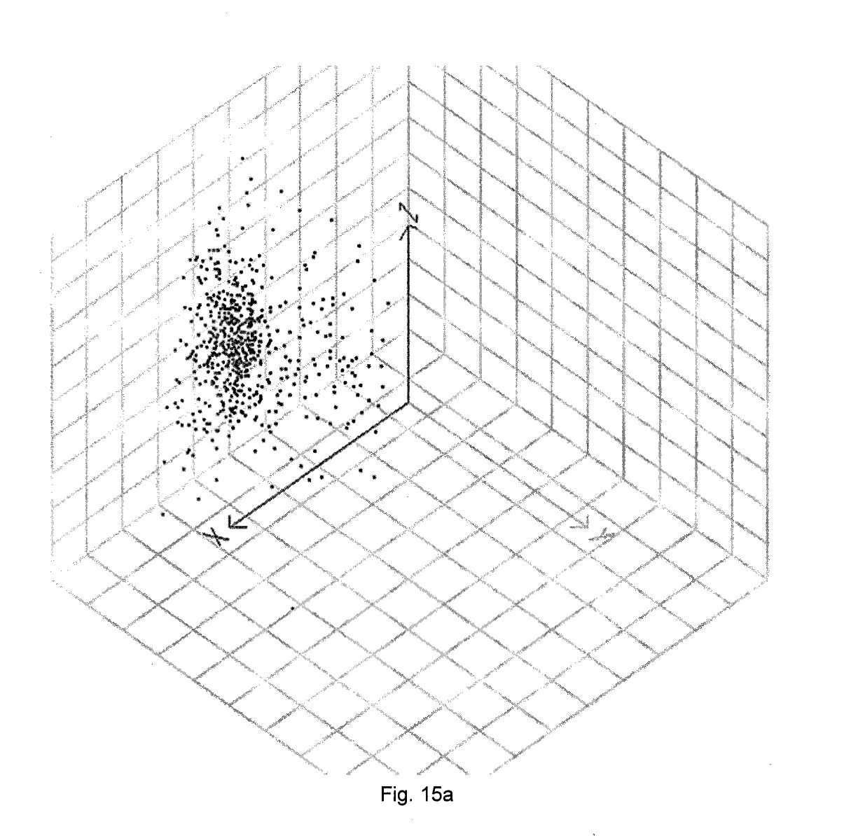

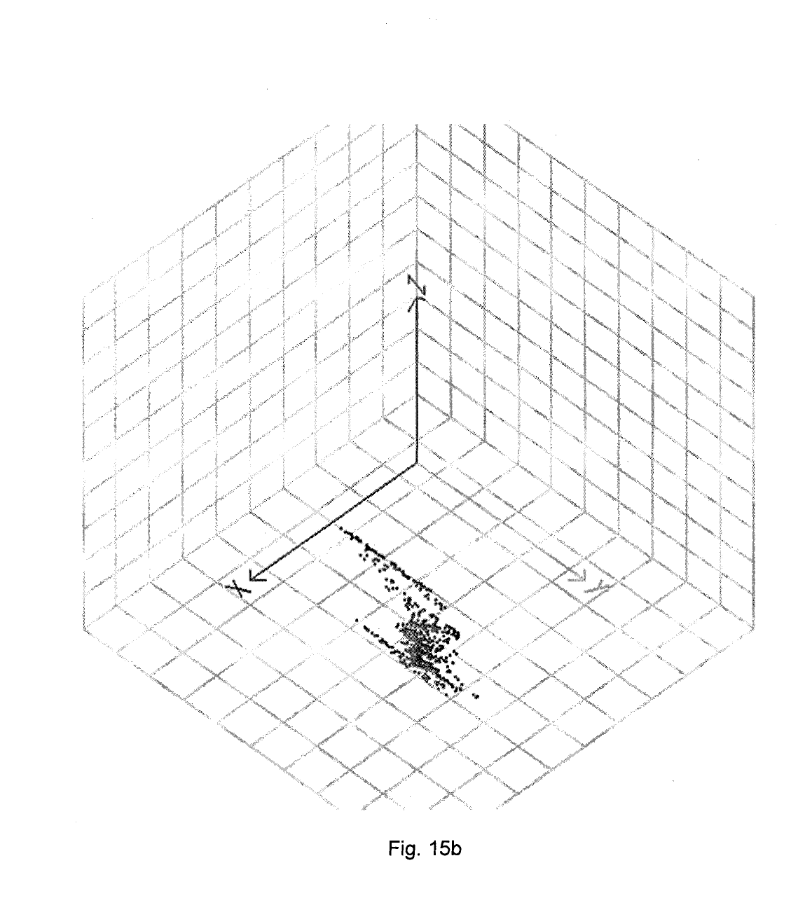

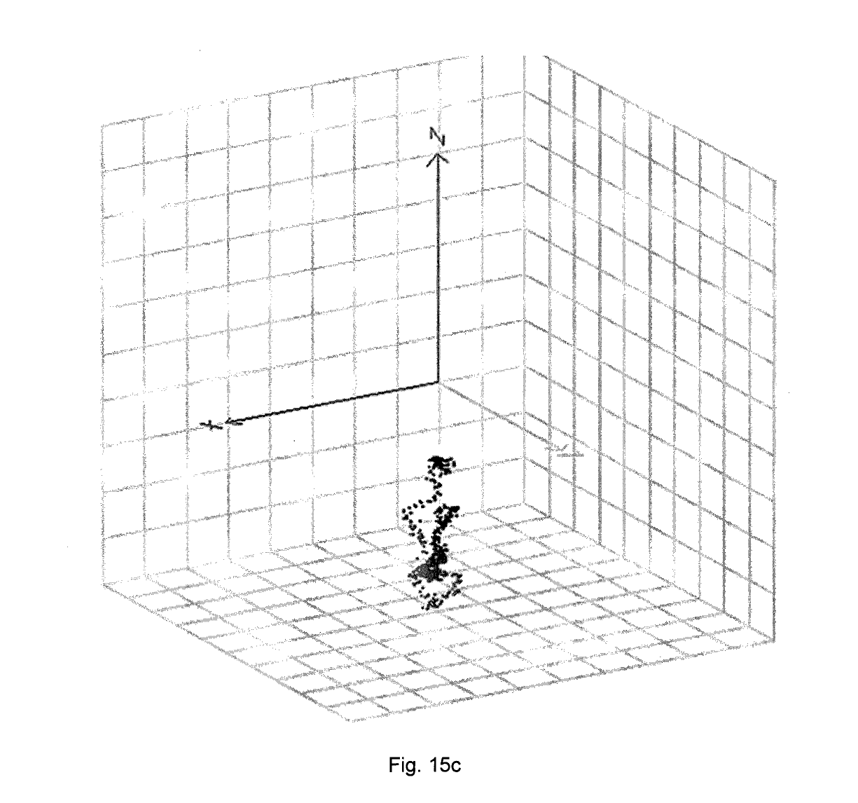

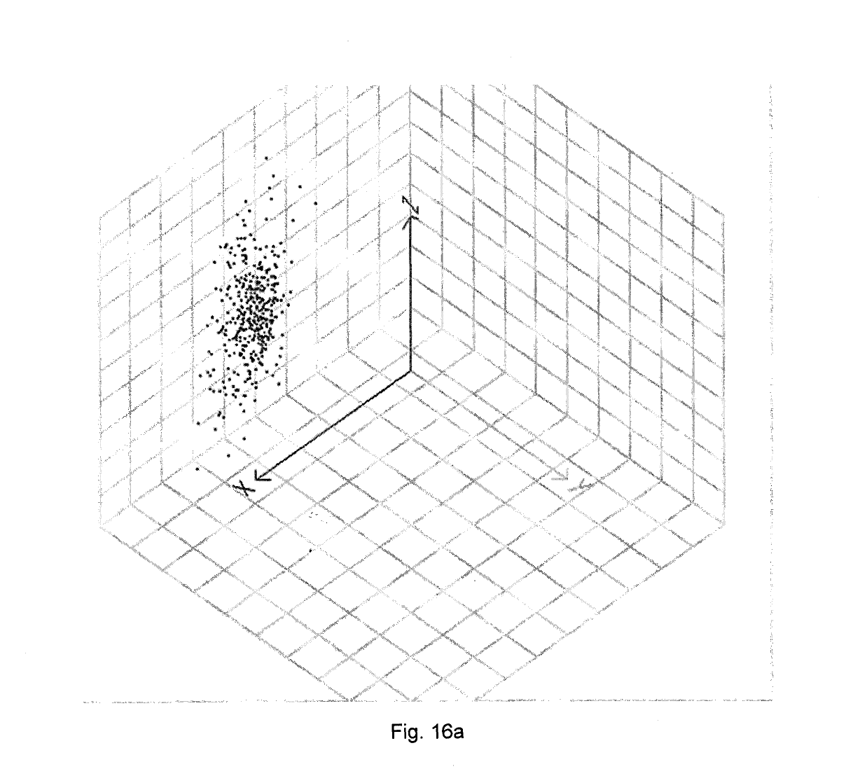

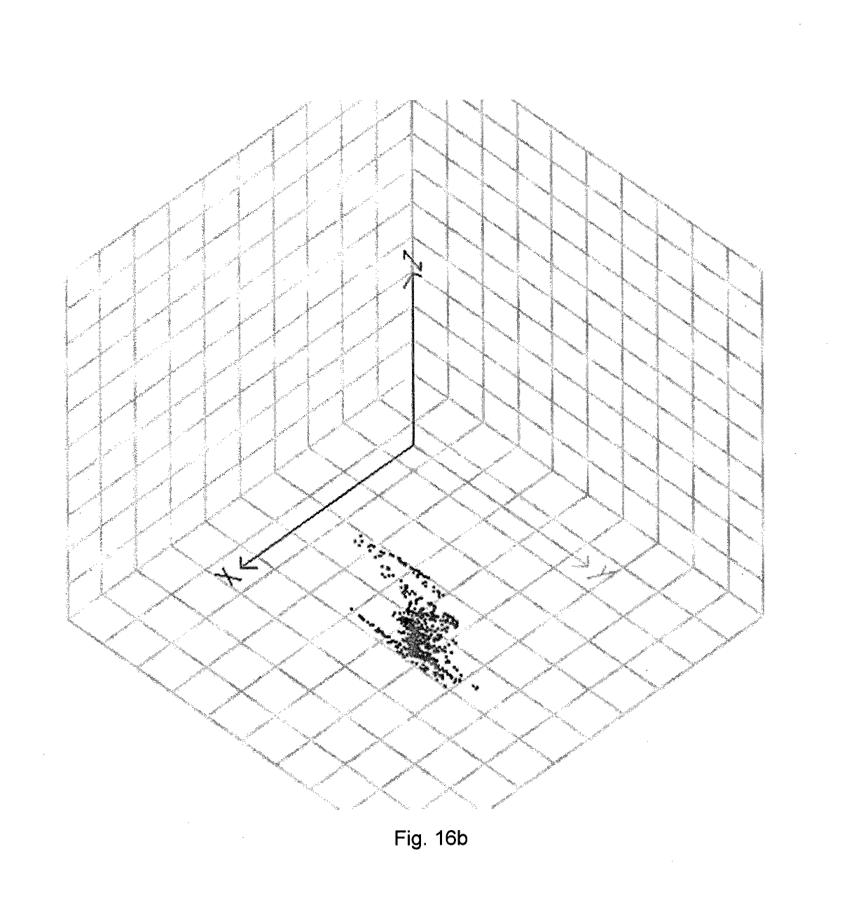

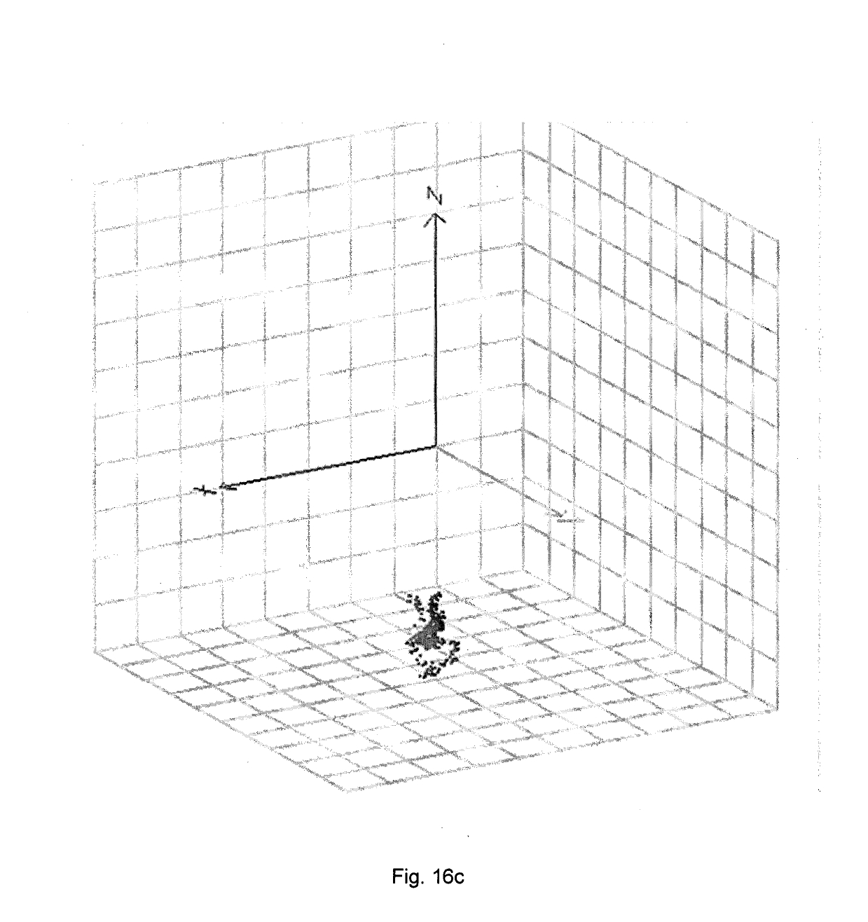

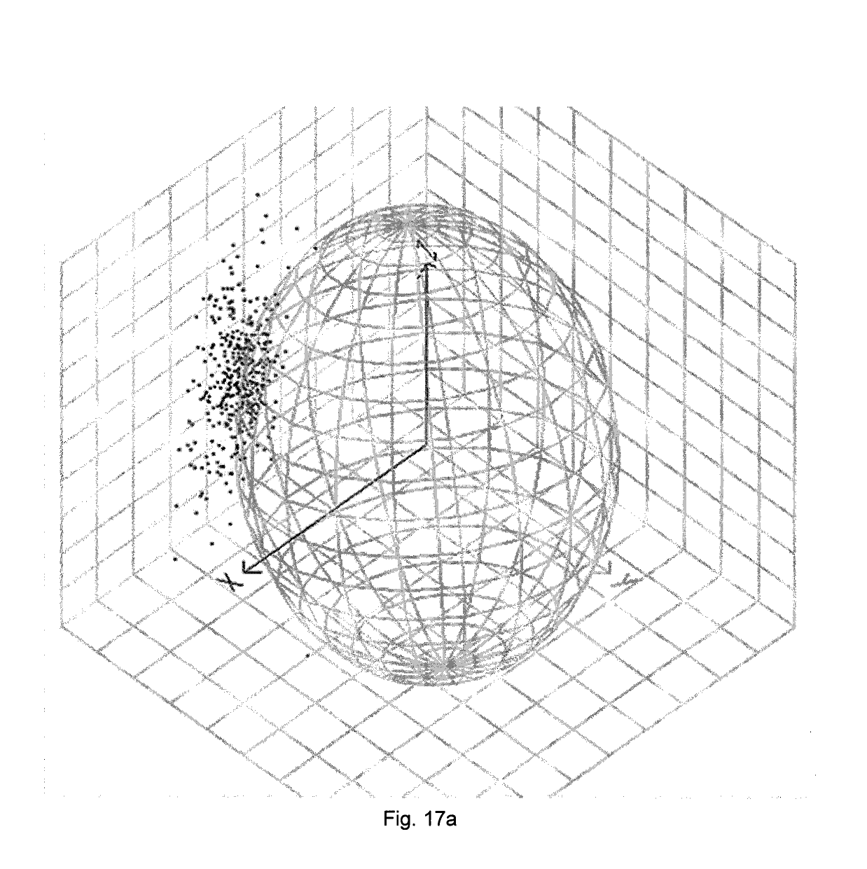

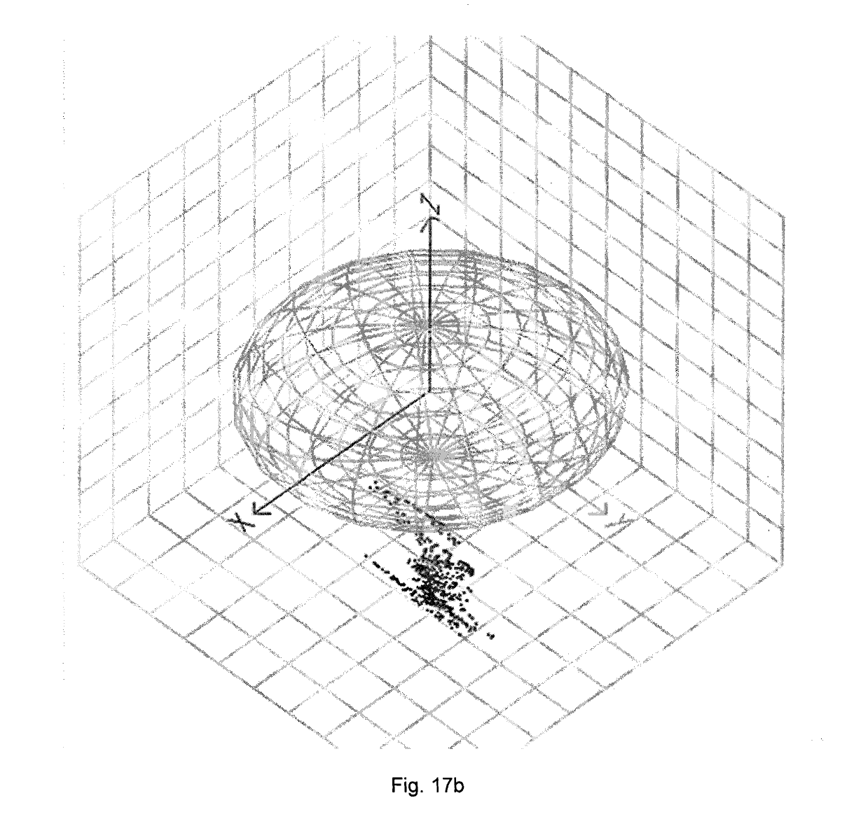

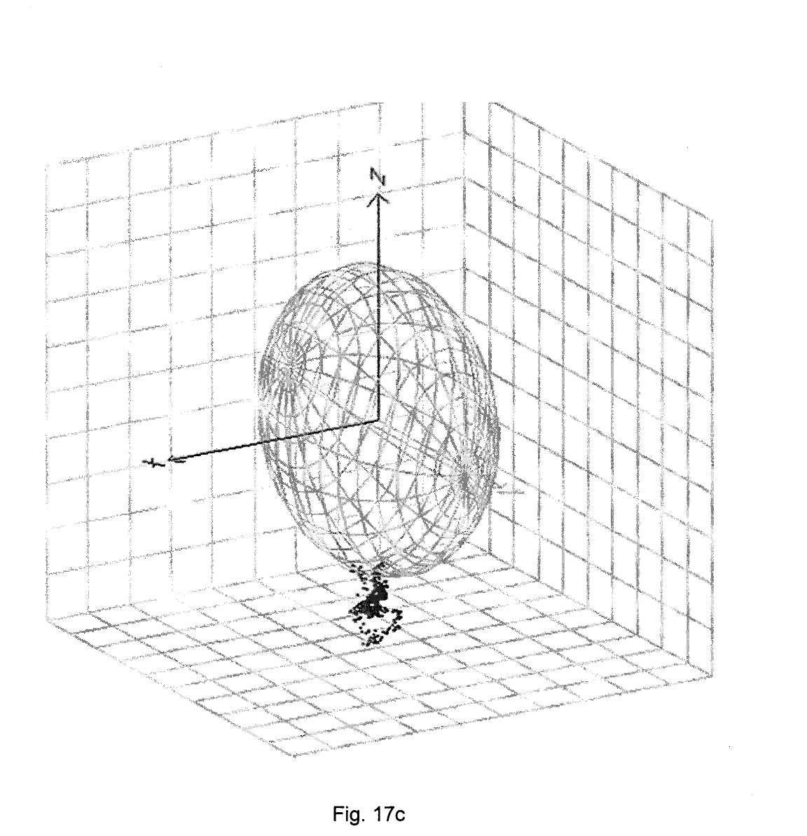

FIG. 15 corresponds to FIG. 14 but also the reference models have been hidden thereby only showing the 600 data points. FIG. 16 shows only the datapoints that fall outside the reference models. FIG. 17 shows the datapoints that fall outside the reference models depicted along with the corresponding reference models. For both x, y and z acceleration in FIG. 13a, angular orientation in FIG. 13c and speed and x-y acceleration in FIG. 13b the three second status model is seen to be clearly outside the reference model indicating angular movement and acceleration. The turn was a left turn and during the left turn the driver was accelerating while passing over a flat bump in the road. The acceleration and the bump can be seen from FIGS. 13a-17a where the driver acceleration is visualized along the x-axis and the bump is visualized via the z-axis. The left turn is visualized via clearly negative yaw rate in FIGS. 13b-17b, whereas roll and pitch movements are limited. That the three second status models are falls at least partly outside the reference models showing normal driving, illustrates the fact three seconds is a very short time window for collection of data, and that a left turn wherein the driver accelerates is a seldom incident during “normal” driving behavior. A more appropriate reference model in this case could have been based on a collection of data from left turns, thereby providing a better picture of whether this left turn was indeed an unusual incident.

The pattern formed by such a “left turn over flat bump” may be used to form a new feature or it may be characterized as an incident. Data acquired from other tours, e.g. performed by the same driver, can then be analyzed to reveal other left turns over flat bumps conducted on other tours, e.g. by analyzing short time windows searching for the same structure, e.g. in the outliers. This might reveal an inappropriate driving behavior subjecting the vehicle to unnecessary load and wear.

### Further Details

The present will now be described in further detail with reference to the following items:
1. A (computer implemented) method for obtaining one or more reference models representative of the normal condition of a vehicle during use, the method comprising the steps of
   acquiring vehicle monitoring data comprising a plurality of parameters indicative of the triple-axis proper acceleration, angular orientation, velocity and location of the vehicle sampled over a time period,
   selecting one or more subsets of said vehicle monitoring data parameters,
   applying an orthogonal transformation to each subset thereby obtaining a set of linearly uncorrelated eigenvectors for each subset, and
   computing a multi-dimensional reference model for each subset, such as by forming ellipsoids of the corresponding eigenvectors.
2. The method according to any of preceding items 1, further comprising the step of combining a plurality of reference models obtained from the same type of vehicle to compute a reference model for said vehicle type.
3. The method according to any of preceding items, further comprising the step of combining a plurality of reference models obtained from a group of vehicles to compute a reference model for said group of vehicles.
4. A (computer implemented) method for obtaining one or more labelled reference models representative of the normal condition of a vehicle during labelled use, the method comprising the steps of
   acquiring vehicle monitoring data comprising a plurality of parameters indicative of the triple-axis proper acceleration, angular orientation, velocity and location/position of the vehicle sampled over a time period,
   labelling the acquired data with respect to driving condition to obtain one or more labelled subsets, each labelled subset assigned a specific label,
   applying an orthogonal transformation to each labelled subset thereby obtaining a set of eigenvectors for each labelled subset,
   computing a multi-dimensional labelled reference model for each labelled subset, such as by forming ellipsoids of the corresponding eigenvectors.
5. A (computer implemented) method for obtaining one or more reference models representative of the normal condition of a vehicle during use, the method comprising the steps of
   acquiring vehicle monitoring data comprising a plurality of parameters indicative of the triple-axis proper acceleration, angular orientation, velocity and location of the vehicle sampled over a time period,
   selecting one or more subsets of said vehicle monitoring data parameters,
   applying an sparse transformation to each subset thereby obtaining a set of loading vectors for each subset, and
   computing a multi-dimensional reference model for each subset based on one or more of said loading vectors.
6. The method according to any of preceding items 1, further comprising the step of combining a plurality of reference models obtained from the same type of vehicle to compute a reference model for said vehicle type.
7. The method according to any of preceding items, further comprising the step of combining a plurality of reference models obtained from a group of vehicles to compute a reference model for said group of vehicles.
8. A (computer implemented) method for obtaining one or more labelled reference models representative of the normal condition of a vehicle during labelled use, the method comprising the steps of
   acquiring vehicle monitoring data comprising a plurality of parameters indicative of the triple-axis proper acceleration, angular orientation, velocity and location/position of the vehicle sampled over a time period,
   labelling the acquired data with respect to driving condition to obtain one or more labelled subsets, each labelled subset assigned a specific label,
   applying a sparse transformation to each labelled subset thereby obtaining a set of loading vectors for each labelled subset,
   computing a multi-dimensional labelled reference model for each labelled subset based on one or more of said loading vectors.
9. The method according to any of preceding items, wherein data are acquired during one or more test runs of the vehicle exposing the vehicle to different driving conditions.
10. The method according to any of preceding items, wherein the multi-dimensional reference model is computed by expanding the ellipsoid, preferably equally in all directions, until a predefined percentage of the data parameters of the corresponding subset is contained inside the expanded ellipsoid.
11. The method according to item 10, wherein said percentage is at least 90%, 92%, 94%, 95%, 96%, 97%, 98%, 99%, or at least 99.5%.
12. The method according to any of preceding items, wherein the multi-dimensional reference model is computed by including a predefined percentile of the data parameters.
13. The method according to item 12, wherein said percentile is at least 90%, 92%, 94%, 95%, 96%, 97%, 98%, 99%, or at least 99.5%.
14. The method according to any of preceding items 4 to 13, wherein the data labelling is provided by means of a decision tree model, a Bayes classification model or a jump process model.
15. The method according to any of preceding items 4 to 14, further comprising the step of combining a plurality of equally labelled reference models obtained from the same type of vehicle to compute a labelled reference model for said vehicle type.
16. The method according to any of preceding items 4 to 15, further comprising the step of combining a plurality of equally labelled reference models obtained from a group of vehicles to compute a labelled reference model for said group of vehicles.
17. The method according to any of preceding items, further comprising the step of adding additional vehicle monitoring data to the reference model acquired during a further time period.
18. A (computer implemented) method for assessing the condition of a vehicle comprising the steps of
   acquiring data indicative of the triple-axis proper acceleration, angular orientation, velocity and location of the vehicle sampled over a time period,
   selecting one or more subsets of said vehicle monitoring data parameters, and
   evaluating the condition of the vehicle by comparing at least one of said subsets to at least one reference model of the vehicle.
19. The method according to item 18, wherein the reference model is obtained according to the method of any of items 1 to 17.
20. A (computer implemented) method for assessing the condition of a vehicle comprising the steps of
   acquiring data indicative of the triple-axis proper acceleration, angular orientation, velocity and location of the vehicle sampled over a time period,
   selecting one or more subsets of said vehicle monitoring data parameters,
   applying an orthogonal transformation of at least one of said subsets thereby obtaining a set of eigenvectors for said subset,
   computing a multi-dimensional status model of the vehicle, such as by forming an ellipsoid of said set of eigenvectors,
   evaluating the condition of the vehicle by comparing the status model to a reference model of the vehicle.
21. A (computer implemented) method for assessing the condition of a vehicle comprising the steps of
   acquiring data indicative of the triple-axis proper acceleration, angular orientation, velocity and location of the vehicle sampled over a time period,
   selecting one or more subsets of said vehicle monitoring data parameters,
   applying an sparse transformation of at least one of said subsets thereby obtaining a set of loading vectors for said subset,
   computing a multi-dimensional status model of the vehicle based on one or more of said loading vectors,
   evaluating the condition of the vehicle by comparing the status model to a reference model of the vehicle.
22. The method according to any of preceding items, wherein the orthonormal transformation is a principal component analysis (PCA) and the eigenvectors correspond to principal components of said PCA.
23. The method according to any of preceding items, wherein the sparse transformation is a sparse principal component analysis (SPCA).
24. The method according to any of preceding items 20 to 23, wherein an abnormal condition of the vehicle is when the volume of the status model is greater than the volume of the reference model.
25. The method according to any of preceding items 20 to 24, wherein an abnormal condition of the vehicle is when at least a part of the status model diverges from the reference model.
26. The method according to any of preceding items 20 to 25, wherein an abnormal condition of the vehicle is when the length of one or more of the eigenvectors or loading vectors of the status model exceed the length of the corresponding eigenvector(s) or loading vector(s) of the reference model.
27. The method according to any of preceding items 20 to 26, wherein an abnormal condition of the vehicle is when the direction/orientation of one or more of the eigenvectors or loading vectors of the status model diverges from the direction/orientation of the corresponding eigenvector(s) or loading vectors of the reference model.
28. The method according to any of preceding items 20 to 27, wherein an abnormal condition of the vehicle is when the ratio of two of the eigenvectors or loading vectors of the status model diverges from the ratio of the two corresponding eigenvectors or loading vectors of the reference model.
29. The method according to any of preceding items 20 to 28, further comprising the step of labelling the acquired data with respect to driving condition to obtain one or more labelled subsets, each labelled subset assigned a specific label.
30. The method according to any of preceding items 20 to 29, wherein the reference model is a labelled reference model that has been labelled with respect to driving condition.
31. The method according to any of preceding items 18 to 30, wherein an abnormal condition of the vehicle is when a predefined ratio of one or more of the data parameters of one of said subsets is outside the reference model.
32. The method according to any of preceding items 18 to 31, wherein the severity of an abnormal condition of the vehicle is based on the ratio of data parameters of one of said subsets that are outside the reference model.
33. The method according to any of preceding items 18 to 32, wherein the severity of an abnormal condition of the vehicle is based on the distance between the reference model and one or more of the data parameters that are outside the reference model, such as the distance to the surface of the reference model ellipsoid.
34. The method according to any of preceding items 18 to 33, further comprising the step of assessing the condition of the vehicle by detecting outlier clusters of data parameters that are outside of the reference model.
35. The method according to item 34, wherein an outlier cluster is defined as a predefined ratio or number of data parameters that are outside of the reference model and located within a predefined angular section of the model.
36. The method according to any of preceding items 34 to 35, further comprising the step of determining a principal direction and/or angular coordinate of said outlier cluster(s), such as determining the midpoint of said outlier cluster(s) and determining the direction, such as angular coordinates, of the midpoint.
37. The method according to any of preceding items, wherein the monitoring data relating to angular orientation, velocity and/or location are optional.
38. The method according to any of preceding items, wherein the vehicle monitoring data further comprises data acquired from one or more electronic control units located in the vehicle sampled over said time period, electronic control units such as the engine control unit, the powertrain control module, the transmission control unit, antilock braking control unit, cruise control unit, or power steering unit.
39. The method according to any of preceding items, wherein the vehicle monitoring data further comprises a plurality of parameters indicative of the movement, acceleration and/or angular orientation of one or more internal moving parts of the vehicle sampled over said time period.
40. The method according to any of preceding items, further comprising the step of pre-filtering the acquired data, such as to delete extreme outliers, such as deleting the outermost 1%, or 0.5%, 0.4%, 0.3%, 0.2%, 0.1%, 0.05%, 0.01% of the data.
41. The method according to any of preceding items 18 to 40, wherein the reference model is obtained according to the method of any of items 1 to 17.
42. The method according to any of preceding items, wherein the subsets are labelled with respect to driving condition in terms of:
   general condition of vehicle, such as engine off, engine idle, driving
   terrain, such as on-road or off-road
   road type, such as asphalt, highway, freeway, gravel road, small country road, cobblestone,
   off-road type, such as smooth, medium, or rough
   geography, such as city, suburban, municipal, countryside,
   driver, such as identity, age, gender, nationality or experience,
   driving style, such as hard driving style, normal driving style or gentle driving style,
   directional movements: x-, y- or z-axis movements,
   angular movements: pitch, roll or yaw
43. The method according to any of preceding items, wherein at least a part of the labelling is conducted automatically.
44. The method according to any of preceding items, wherein data are acquired with a predetermined sample frequency of at least 50 Hz, or at least 100 Hz, or at least 200 Hz.
45. A support system for assessing the condition of a plurality of vehicles, comprising a computer having memory and processor and configured to execute the method according to any of preceding items 18 to 44.
46. A monitoring system for attachment to a vehicle and for monitoring the condition of said vehicle, comprising
   at least one inertial measurement unit configured to measure the triple-axis proper acceleration, and angular orientation of the chassis of the vehicle sampled over a time period,
   at least one GPS receiver for continuously measuring the location of the vehicle,
   a computer comprising memory and a processing unit, configured for executing the method according to any of preceding items 18 to 44 for assessing the condition of said vehicle.
47. The monitoring system according to item 46, further comprising one or more additional movement detectors, such as accelerometer, gyroscope, or initial measurement unit, mounted on one or more internal moving parts of the vehicle for measuring the movement, acceleration and/or angular orientation of said part(s).
48. The monitoring system according to any of preceding items 46 to 47, wherein the monitoring system is configured to continuously measure the velocity of the vehicle based on triple axis proper acceleration data and/or location data.
49. The vehicle monitoring system according to any of preceding items 46 to 48, wherein the inertial measurement unit(s) has a static accuracy of less than ±1°, preferably less than ±0.5°, pitch and roll.
50. The vehicle monitoring system according to any of preceding items 46 to 49, wherein the inertial measurement unit(s) has a dynamic accuracy of less than ±3°, preferable less than ±2.0° pitch and roll.
51. The vehicle monitoring system according to any of preceding items 46 to 50, wherein the inertial measurement unit(s) has a neglectable long term drift.
52. The vehicle monitoring system according to any of preceding items 46 to 51, wherein the inertial measurement unit(s) has a repeatability of less than 0.2°.
53. The vehicle monitoring system according to any of preceding items 46 to 52, wherein the inertial measurement unit(s) has a resolution less than 0.1°.
54. The vehicle monitoring system according to any of preceding items 46 to 53, wherein the condition of the vehicle is computed in real-time
55. The vehicle monitoring system according to any of preceding items 46 to 54, wherein the condition of the vehicle is displayed in a display in the vehicle.
56. The vehicle monitoring system according to any of preceding items 46 to 55, further comprising a wireless transmitter.
57. The vehicle monitoring system according to any of preceding items 46 to 56, wherein the condition of the vehicle is transmitted to a server system by means of a wireless transmitter.

1. A (computer implemented) method for assessing the condition of a vehicle comprising the steps of
acquiring data indicative of the triple-axis proper acceleration, angular orientation, velocity and location of the vehicle sampled over a time period,
selecting one or more subsets of said vehicle monitoring data parameters,
applying an orthogonal transformation of at least one of said subsets thereby obtaining a set of eigenvectors for said subset,
computing a multi-dimensional status model of the vehicle, such as by forming an ellipsoid of said set of eigenvectors,
evaluating the condition of the vehicle by comparing the status model to a reference model of the vehicle.

2. The method according to any of preceding claims, wherein the orthonormal transformation is a principal component analysis (PCA) and the eigenvectors correspond to principal components of said PCA.

3. The method according to any of preceding claims, wherein an abnormal condition of the vehicle is when the volume of the status model is greater than the volume of the reference model.

4. The method according to any of preceding claims, wherein an abnormal condition of the vehicle is when at least a part of the status model diverges from the reference model.

5. The method according to any of preceding claims, wherein an abnormal condition of the vehicle is when the length of one or more of the eigenvectors or loading vectors of the status model exceed the length of the corresponding eigenvector(s) of the reference model.

6. The method according to any of preceding claims, wherein an abnormal condition of the vehicle is when the direction/orientation of one or more of the eigenvectors of the status model diverges from the direction/orientation of the corresponding eigenvector(s) of the reference model.

7. The method according to any of preceding claims, wherein an abnormal condition of the vehicle is when the ratio of two of the eigenvectors of the status model diverges from the ratio of the two corresponding eigenvectors of the reference model.

8. The method according to any of preceding claims, further comprising the step of labelling the acquired data with respect to driving condition to obtain one or more labelled subsets, each labelled subset assigned a specific label.

9. The method according to any of preceding claims, wherein the reference model is a labelled reference model that has been labelled with respect to driving condition.

10. The method according to any of preceding claims, wherein an abnormal condition of the vehicle is when a predefined ratio of one or more of the data parameters of one of said subsets is outside the reference model.

11. The method according to any of preceding claims, wherein the severity of an abnormal condition of the vehicle is based on the ratio of data parameters of one of said subsets that are outside the reference model.

12. The method according to any of preceding claims, wherein the severity of an abnormal condition of the vehicle is based on the distance between the reference model and one or more of the data parameters that are outside the reference model, such as the distance to the surface of the reference model ellipsoid.

13. The method according to any of preceding claims, further comprising the step of assessing the condition of the vehicle by detecting outlier clusters of data parameters that are outside of the reference model, wherein an outlier cluster is defined as a predefined ratio or number of data parameters that are outside of the reference model and located within a predefined angular section of the model.

14. The method according to any of preceding claim 13, further comprising the step of determining a principal direction and/or angular coordinate of said outlier cluster(s), such as determining the midpoint of said outlier cluster(s) and determining the direction, such as angular coordinates, of the midpoint.

15. The method according to any of preceding claims, wherein the vehicle monitoring data further comprises data acquired from one or more electronic control units located in the vehicle sampled over said time period, electronic control units such as the engine control unit, the powertrain control module, the transmission control unit, antilock braking control unit, cruise control unit, or power steering unit, such as vehicle monitoring data in the form of CAN bus dat.

16. The method according to any of preceding claims, wherein the vehicle monitoring data further comprises a plurality of parameters indicative of the movement, acceleration and/or angular orientation of one or more internal moving parts of the vehicle sampled over said time period.

17. The method according to any of preceding claims, wherein the reference model is obtained according to the method of any of claims 27 to 36.

18. The method according to any of preceding claims, wherein the subsets are labelled with respect to driving condition in terms of:
general condition of vehicle, such as engine off, engine idle, driving
terrain, such as on-road or off-road
road type, such as asphalt, highway, freeway, gravel road, small country road, cobblestone,
off-road type, such as smooth, medium, or rough
geography, such as city, suburban, municipal, countryside,
driver, such as identity, age, gender, nationality or experience,
driving style, such as hard driving style, normal driving style or gentle driving style,
directional movements: x-, y- or z-axis movements, and/or
angular movements: pitch, roll or yaw

19. The method according to any of preceding claims, wherein data are acquired with a predetermined sample frequency of at least 50 Hz, more preferably at least 100 Hz, most preferably at least 200 Hz.

20. A monitoring system for attachment to a vehicle and for monitoring the condition of said vehicle, comprising
at least one inertial measurement unit configured to measure the triple-axis proper acceleration, and angular orientation of the chassis of the vehicle sampled over a time period,
at least one GPS receiver for continuously measuring the location of the vehicle,
a computer comprising memory and a processing unit, configured for executing the method according to any of preceding claims for assessing the condition of said vehicle.

21. The monitoring system according to claim 20, further comprising one or more additional movement detectors, such as accelerometer, gyroscope, or initial measurement unit, mounted on one or more internal moving parts of the vehicle for measuring the movement, acceleration and/or angular orientation of said part(s).

22. The monitoring system according to any of preceding claims 20 to 21, wherein the monitoring system is configured to continuously measure the velocity of the vehicle based on triple axis proper acceleration data and/or location data.

23. The vehicle monitoring system according to any of preceding claims 20 to 22, wherein the inertial measurement unit(s) has a static accuracy of less than ±1°, preferably less than ±0.5°, pitch and roll, and wherein the inertial measurement unit(s) has a dynamic accuracy of less than ±3°, preferable less than ±2.0° pitch and roll.

24. The vehicle monitoring system according to any of preceding claims 20 to 23, wherein the inertial measurement unit(s) has a repeatability of less than 0.2° and wherein the inertial measurement unit(s) has a resolution less than 0.1°.

25. The vehicle monitoring system according to any of preceding claims 20 to 24, wherein the condition of the vehicle is computed in real-time.

26. The vehicle monitoring system according to any of preceding claims 20 to 25, wherein the condition of the vehicle is displayed in a display in the vehicle.

27. A (computer implemented) method for obtaining one or more reference models representative of the normal condition of a vehicle during use, the method comprising the steps of
acquiring vehicle monitoring data comprising a plurality of parameters indicative of the triple-axis proper acceleration, angular orientation, velocity and location of the vehicle sampled over a time period,
selecting one or more subsets of said vehicle monitoring data parameters,
applying an orthogonal transformation to each subset thereby obtaining a set of linearly uncorrelated eigenvectors for each subset, and
computing a multi-dimensional reference model for each subset, such as by forming ellipsoids of the corresponding eigenvectors.

28. The method according to any of preceding claim 27, further comprising the step of combining a plurality of reference models obtained from the same type of vehicle to compute a reference model for said vehicle type, and/or further comprising the step of combining a plurality of reference models obtained from a group of vehicles to compute a reference model for said group of vehicles.

29. A (computer implemented) method for obtaining one or more labelled reference models representative of the normal condition of a vehicle during labelled use, the method comprising the steps of
acquiring vehicle monitoring data comprising a plurality of parameters indicative of the triple-axis proper acceleration, angular orientation, velocity and location/position of the vehicle sampled over a time period,
labelling the acquired data with respect to driving condition to obtain one or more labelled subsets, each labelled subset assigned a specific label,
applying an orthogonal transformation to each labelled subset thereby obtaining a set of eigenvectors for each labelled subset,
computing a multi-dimensional labelled reference model for each labelled subset, such as by forming ellipsoids of the corresponding eigenvectors.

30. The method according to any of preceding claims 27 to 29, wherein data are acquired during one or more test runs of the vehicle exposing the vehicle to different predefined driving conditions.

31. The method according to any of preceding claims 27 to 30, wherein the multi-dimensional reference model is computed by expanding the ellipsoid, preferably equally in all directions, until a predefined percentage of the data parameters of the corresponding subset is contained inside the expanded ellipsoid.

32. The method according to claim 31, wherein said percentage is at least 90%, 92%, 94%, 95%, 96%, 97%, 98%, 99%, or at least 99.5%.

33. The method according to any of preceding claims 27 to 32, wherein the data labelling is provided by means of a decision tree model, a Bayes classification model or a jump process model.

34. The method according to any of preceding claims 27 to 33, further comprising the step of combining a plurality of equally labelled reference models obtained from the same type of vehicle to compute a labelled reference model for said vehicle type.

35. The method according to any of preceding claims 27 to 34, further comprising the step of combining a plurality of equally labelled reference models obtained from a group of vehicles to compute a labelled reference model for said group of vehicles.

36. The method according to any of preceding claims 27 to 35, further comprising the step of adding additional vehicle monitoring data to the reference model acquired during a further time period.
